(19) United States
(12) Patent Application Publication
(10) Pub. No.: US 2018/0266559 A1
(43) Pub. Date: Sep. 20, 2018

(54) FLAT GASKET AND SEALING ASSEMBLY CONTAINING A FLAT GASKET

(71) Applicant: ElringKlinger AG, Dettingen (DE)

(72) Inventor: Frank Schmucker, Ehingen (DE)

(21) Appl. No.: 15/988,502

(22) Filed: May 24, 2018

Related U.S. Application Data
(63) Continuation of application No. PCT/EP2016/078285, filed on Nov. 21, 2016.

(30) Foreign Application Priority Data
Nov. 25, 2015 (DE) 10 2015 120 452.5
Nov. 30, 2015 (DE) 10 2015 120 782.6

(51) Int. Cl. F16J 15/08

(52) U.S. Cl. CPC F16J 15/0825; F16J 2015/0868; F16J 2015/0862; F16J 2015/085

(57) ABSTRACT

An at least substantially metallic flat gasket which has at least one media passage opening and screw holes for the passage of mounting screws used to clamp the flat gasket is disclosed. The flat gasket includes at least one gasket layer at least around the media passage opening, at least one gasket layer with a sealing bead surrounding the media passage opening, and at least one gasket layer for limiting the deformation of the sealing bead is provided with a stopper, which at least substantially surrounds the media passage opening. The flat gasket includes a means for evening out the compression of the stopper along the length thereof, wherein the means includes at least one component support element which is provided only over a longitudinal portion of the stopper, and is configured such that the flat gasket is locally thicker than in regions of stopper longitudinal portions immediately adjacent.

### CROSS-REFERENCE TO RELATED APPLICATIONS

This application is a continuation of international application number PCT/EP2016/078285, filed Nov. 21, 2016, which claims the benefit of German application Nos. 10 2015 120 452.5, filed Nov. 25, 2015, and 10 2015 120 782.6, filed Nov. 30, 2015, each of which is incorporated by reference in its entirety.

### FIELD OF THE INVENTION

The invention relates to an at least substantially metallic flat gasket which is clampable between components and which has at least one media passage opening and screw holes for the passage of mounting screws used to clamp the flat gasket, wherein the flat gasket comprises at least one gasket layer at least around the media passage opening, which gasket layer extends preferably over at least the majority of the flat gasket, at least one gasket layer with a preferably highly resilient sealing bead surrounding the media passage opening, and at least one gasket layer for limiting the deformation of the sealing bead is provided with a stopper, which at least substantially surrounds the media passage opening, and wherein the flat gasket comprises means for spatially evening out the compression of the stopper of the installed flat gasket (specifically for evening out along the stopper).

In particular, the invention relates to a flat gasket of this kind formed as a cylinder head gasket; in this case the media passage opening is in particular a combustion chamber passage opening associated with an engine cylinder. The invention also relates to what is known as a sealing assembly with a substantially metallic flat gasket of the above kind clamped between components, wherein at least one of the components has a locally different component stiffness in the direction perpendicular to the plane defined by the flat gasket.

If the flat gasket is a cylinder head gasket, the components of the aforesaid sealing assembly comprise the engine block and at least one cylinder head of a reciprocating internal combustion engine, which receive between them the cylinder head gasket (or cylinder head gaskets in the case of an engine having a plurality of cylinder heads) and are clamped together (in the direction perpendicular to the plane defined by the cylinder head gasket or the cylinder head gaskets) by means of mounting screws (cylinder head screws).

The invention, however, also relates to other flat gaskets and sealing assemblies, such as what is known as an exhaust manifold gasket of a reciprocating internal combustion engine, which is installed between a cylinder head and what is known as an exhaust manifold.

In the case of a cylinder head gasket, the above-mentioned media passage opening, as already known, is in particular a combustion chamber opening associated with a cylinder of the engine, but could also be a passage opening for cooling water or engine oil; in the case of an exhaust manifold gasket, the media passage opening forms an exhaust gas opening.

Where reference is made above to an at least substantially metallic flat gasket having at least one gasket layer, this means that a conventional gasket layer produced from sheet steel (sheet spring steel as necessary) or a plurality of gasket layers of this kind does/do not have to be purely metallic, but instead can be coated with a non-metallic material, for example with a material used for what is known as micro sealing or a material with which the sliding friction is reduced, or that another gasket element is not purely metallic or as appropriate consists of a non-metallic material.

The at least one gasket layer preferably extends over the entire flat gasket, however the invention also relates to flat gaskets in which a gasket layer or a plurality of gasket layers extends/extend over only part of the flat gasket.

In the case of a single-layer or multi-layer flat gasket of the kind mentioned in the introduction, the sealing bead associated with a media passage opening and the stopper associated with the sealing bead can be provided on or in the same gasket layer or each can be provided on or in one of a plurality of gasket layers. In addition, as is already known in the case of flat gaskets, a plurality of stoppers can be provided for one sealing bead, in particular a first stopper provided between the sealing bead and the edge of the media passage opening, and a second stopper, which is arranged behind the sealing bead as considered from the media passage opening. If just one stopper is provided for a sealing bead, this stopper lies preferably between the sealing bead and the media passage opening associated therewith as considered in a plan view of the flat gasket.

### BACKGROUND OF THE INVENTION

As is the case in known substantially metallic flat gaskets, the stopper is a substantially elongate (in a plan view of the flat gasket) and usually at least approximately circular ring-shaped structure, which does not necessarily have to be continuous, but surrounds the associated media passage opening preferably without gaps, or at least largely surrounds said opening. In some cylinder head gaskets for multi-cylinder engines, the stoppers associated with the combustion chamber openings of these cylinder head gaskets each have a gap in the web-like regions of the cylinder head gasket provided between mutually adjacent combustion chamber openings. In a plan view of the flat gasket, the stopper does not have to have the same width around the entire media passage opening associated with said stopper, and instead can have a width that varies along the length of the stopper, that is to say can have what is known as a width profile.

The components between which the flat gasket is clamped with the aid of mounting screws cannot be considered to be absolutely rigid components, and therefore reference is made to the following: Since the clamping forces are generated by the mounting screws and therefore are only introduced into the components and the flat gasket more or less at specific points, distortions of the components receiving the flat gasket between them cannot be avoided: In the screw regions, the mounting screws cause a maximal approach of the components towards one another, whereas the spacing between the components in what are known as inter-screw regions (the regions lying between the mounting screws), said spacing being measured in a direction perpendicular to the flat gasket plane, becomes larger with increasing spacing from the mounting screws on account of the reaction forces of the clamped flat gasket and the resultant resilient deformations of the components. This alone means that the clamping forces applied by the mounting screws are not distributed uniformly over the entire flat gasket. In addition, the components do not have the same mechanical strength everywhere in the direction perpendicular to the plane defined by the flat gasket, in other words they do not have the same component stiffness, and therefore for example the engine block and the cylinder head of a reciprocating internal combustion engine have larger cavities, in particular for cooling water, but also for engine oil, which lead to locally lower component stiffness levels and thus cause the compression forces acting on the installed cylinder head gasket to be even further reduced locally in the inter-screw gaps, without any particular measures being taken.

Amongst other things for the purpose of evening out the locally different compression forces acting on the flat gasket (on account of the introduction, more or less over specific points, of the screw forces into the sealing assembly and the above-described distortions of the components receiving the flat gasket between them), it is known in particular in the case of flat gaskets of the kind mentioned at the outset formed as cylinder head gaskets to provide the stopper or stoppers with what is known as a height profile, that is to say with a profile, the height of which (based on the plane defined by the gasket layer provided with the stopper) along the stopper, that is to say in the peripheral direction of the media passage opening associated with the stopper, varies; here, it is routine to configure the stopper such that its height in the above-mentioned so-called inter-screw regions is greater than in the screw regions, wherein in most cases the stopper height increases continuously with increasing spacing from the screw regions and has its smallest value in the screw regions. If a metallic ring is used as stopper, which ring is attached to a gasket layer, the stopper is produced such that, starting from a metal ring having the same height or thickness everywhere, said ring is provided with a height profile by means of a stamping process, which height profile has its smallest height or thickness at those points of the metal ring which, when the flat gasket is installed, lie closest to the mounting screws. A production method of this kind, however, reaches its limits if the height differences, necessary per se to even out the compression forces, of the height profile that is to be produced exceed a maximum determined above all by the material of the metal ring and the stamping forces available in practice, since the thickness of the used metal ring blank can then no longer be reduced in regions by the stamping process to the extent that would be necessary at the regions of the metal ring arranged close to the screws (when the flat gasket is installed), in order to provide the height or thickness of the metal ring necessary per se in the inter-screw regions. This is true in particular for a stopper that (when the flat gasket is installed) has at least one inter-screw region which (again when the flat gasket is installed) is arranged opposite a component region having a particularly low component stiffness.

The prior art, however, also includes in particular metallic flat gaskets formed as cylinder head gaskets with at least one stopper which has the same height everywhere. If at least one of the components receiving the installed flat gasket between them now has a locally much lower component stiffness in the region of the stopper and/or in the vicinity thereof only at one point or very few points, and this lower stiffness should be compensated for by making the height of the stopper, in its region associated with this point or in its regions associated with these points, greater than in the other stopper regions, the height of the stopper blank would have to be reduced in all of these other stopper regions by the stamping process, which at the least would be uneconomical.

A further problem that occurs with operation of a sealing assembly of the kind defined above will be explained hereinafter on the basis of a flat gasket of the kind defined at the outset in the form of a cylinder head gasket:

Cylinder head gaskets of this kind are generally configured such that the compression forces acting on the installed cylinder head gasket and the forces by which the sealing assembly consisting of engine block, cylinder head gasket and cylinder head is clamped are greatest in the regions of the stoppers surrounding the combustion chamber openings of the cylinder head gasket. As a result, specifically by means of stoppers of this kind, not only are the sealing beads used to seal the combustion chamber openings protected against excessive deformation (flattening), which is damaging for the durability of the sealing beads, but an undesirably high dynamic of what is known as the sealing gap is also avoided during engine operation. The sealing gap is understood to mean the gap between the engine block and the cylinder head in which the cylinder head gasket is received, and the sealing gap dynamic is understood to mean the widening of the sealing gap that occurs in regions during engine operation with the rhythm of the crankshaft rotation, i.e., an increase in the height of the sealing gap on account of the fact that the cylinder head deforms repeatedly for a brief period between the mounting screws (cylinder head screws) on account of the high gas pressures occurring in the engine cylinders, resulting in a repeated increase for a brief period in the spacing of the cylinder head from the engine block. The sealing gap dynamic is particularly high at points of the sealing gap at which at least one of the components delimiting the sealing gap has a locally lower component stiffness, which for example is caused by a relatively large component cavity, adjacent to the sealing gap, for the passage of cooling water or engine oil, in particular when this cavity lies in the cylinder head. It is sought, however, to keep the sealing gap dynamic as small as possible everywhere for the purpose of ensuring the durability of the engine.

### SUMMARY OF THE INVENTION

Proceeding from a flat gasket or a sealing assembly of the kind defined at the outset, the object of the invention was to further improve the evening out of the compression forces acting on the flat gasket and/or to further reduce the sealing gap dynamic occurring during operation, more specifically by means which can be produced relatively inexpensively by known methods.

It is now proposed, in accordance with the invention, to configure a flat gasket of the kind defined in the introduction in such a way that the means for evening out the compression comprise at least one component support element which, in plan view of the flat gasket, is provided only over a longitudinal portion of the stopper and is configured such that, in the region of this stopper longitudinal portion, the flat gasket (in particular in the installed, i.e., compressed state) is locally thicker than in regions of stopper longitudinal portions immediately adjacent to this stopper longitudinal portion.

A component support element is to be understood here as follows:

It can be an element of the flat gasket which causes a region of the flat gasket containing the support element, when said gasket is installed, to dip into, so to speak, an adjacent component region having a local component weakness, that is to say having a component stiffness that is reduced compared to adjacent component regions, and in this way compensates for these local component weaknesses and supports the component locally; however, the support element can also be merely a local supplementation of the stopper so as to thus locally increase the effective overall height of stopper and support element by an amount that, due to production reasons, would not be provided by the stopper alone, or could only be provided with difficulty.

If reference is made above to the fact that the component support element, in a plan view of the flat gasket, is provided only over a longitudinal portion of the stopper, this is to be understood to mean that the component support element is located above or below said longitudinal portion (or longitudinal region) of the stopper depending on the direction of the plan view of the flat gasket. In addition, the component support element can also protrude beyond the stopper radially inwardly and/or radially outwardly (as viewed from the media passage opening) or, in a plan view of the flat gasket, can also be slightly narrower than the stopper. In a plan view of the flat gasket, the component support element should thus be provided only substantially solely over a longitudinal portion or region of the stopper, although embodiments in which, in a plan view of the flat gasket, the component support element lies exclusively above or beneath a stopper longitudinal portion are preferred.

Lastly, if reference is made above and hereinafter to the fact that the flat gasket locally is thicker on account of the component support element, this feature must not be understood to be limiting insofar as the thickness of the flat gasket is to be understood to mean the sum of the material thicknesses of the region of the flat gasket containing the support element. The thickness of this flat gasket region can also be increased in particular in that a protrusion or protrusions is/are stamped locally from the sheet metal of a gasket layer and is/are much more resistant than a sealing bead to deformation in the direction perpendicular to the gasket plane, and in particular is/are as stiff or approximately as stiff as the stoppers. In preferred embodiments of the invention the component support element is thus configured and/or dimensioned and/or the material of the component support element is of such a strength that the height and/or thickness of the component support element does not change, at least not significantly, with the assembly of the flat gasket and during gasket operation, that is to say the component support element can be considered to be resistant to deformation under the compression forces acting thereon.

The stopper longitudinal portions, which are immediately adjacent to the stopper longitudinal portion associated with the component support element, are to be understood to mean the stopper longitudinal regions which, in a plan view of the flat gasket, directly border the stopper longitudinal portion associated with the support element or are directly adjacent thereto.

Inter alia, at least one of the following advantages can be achieved with a flat gasket according to the invention:

The manufacturers of units in which a flat gasket is installed require the gasket manufacturer to produce the flat gasket such that it has a certain ‘installation thickness’. This is understood to mean the thickness of the flat gasket, measured perpendicularly to the gasket plane, in the installed, i.e., compressed, state, and the installation thickness determines the height of the above-explained ‘sealing gap’ between the components receiving the flat gasket between them. The requirement of a certain installation thickness of the flat gasket, for example in the case of a reciprocating internal combustion engine, is based on the fact that the sealing gap height also influences the axial length of a cylinder combustion chamber and therefore what is known as the compression of the engine. The above explanations must also be supplemented by the knowledge that flat gaskets, configured especially as cylinder head gaskets, for a specific engine are often manufactured and supplied by the gasket manufacturer in at least two implementations with different installation thickness, so as to allow any manufacturing tolerances of the engine block and cylinder head encountered by the customer, that is to say the engine manufacturer, to be allowed for by using a cylinder head gasket with an installation thickness by means of which these manufacturing tolerances can be compensated for, so as to attain a desired compression. A specific insulation thickness is thus also to be understood to mean the above-mentioned different installation thicknesses of a flat gasket provided for a specific unit.

In the case of a conventional sealing assembly containing a flat gasket having one or more stoppers, the required installation thickness of the flat gasket must also be achieved by the height of the stopper or stoppers, which height should also be dimensioned such that the above-explained sealing gap dynamic is as low as possible everywhere. If only a strictly limited region of a component is now to be supported on account of a locally strictly limited lower stiffness of this component and at the same time the above-explained requirements on the installation thickness of the flat gasket and the sealing dynamic are to be met, this means, in the case of conventional flat gaskets, that the stopper height has to be reduced in all other stopper regions which are not used to support the aforementioned strictly limited component region of lower stiffness, which is then not only disadvantageous or even impossible due to manufacturing reasons if the stopper height is reduced by means of a stamping process, but also involves the disadvantage that the function of the sealing bead associated with the stopper is impaired on account of the low stopper height over a large part of the length or periphery of the stopper. This is because the degree of compression, i.e., flattening, of the sealing bead of the installed flat gasket (compared to the bead height when the flat gasket is not yet installed, i.e., is not yet compressed) is dependent on the stopper height, and even an only locally excessive flattening of the sealing bead compromises its durability, and in addition what is known as the working point of the sealing bead is shifted by a substantial reduction of the stopper height. The working point of a sealing bead that is dynamically loaded during operation is understood to mean the bead point (in a cross-section through the bead), from which the bead changes its height spring-elastically when subjected to a compression load, i.e., becomes smaller or also larger during operation, wherein the position of the working point can also change depending on the operating state of the sealing assembly. These effects (undesirably high flattening and shifting of the working point of the bead) can be overcome or at least minimised by the at least one component support element provided in accordance with the invention.

In a sealing assembly of the kind defined in the introduction, what are known as sliding movements between the component surfaces receiving the flat gasket between them and the flat gasket itself occur during operation, but also between the gasket layers in the case of a flat gasket comprising a plurality of gasket layers (specifically relative movements in the sealing gap plane), said sliding movements being caused by different temperatures occurring during operation, possibly also only in regions, and accompanying different thermal expansions of the components receiving the flat gasket between them, but in the case of a reciprocating internal combustion engine also by the gas pressures occurring at different times and locations during engine operation. These sliding movements, which lead to signs of wear, can be reduced by the at least one component support element provided in accordance with the invention, since said element leads to a certain local concentration of the compression forces which act between the components and the flat gaskets, and also between the gasket layers in the case of a flat gasket comprising a plurality of gasket layers, and an increase in the compression forces results in an increase of the frictional forces which have to be overcome when sliding movements of this kind occur, such that relative sliding movements between the components of the flat gasket, and also between the gasket layers thereof in the case of a multi-layer flat gasket, are reduced by the at least one component support element provided in accordance with the invention.

As is clear from the comments above, preferred embodiments of the flat gasket according to the invention have at least two gasket layers.

The at least one component support element provided in accordance with the invention can be provided in principle in any way whatsoever on or in the flat gasket, such that the position of said component support element is secured, even during operation. In preferred embodiments of the invention, however, the component support element is provided or formed on or in a gasket layer.

Advantageous embodiments of the invention are characterized by one or, as appropriate, more of the following features:

(i) in the case of a multi-layer gasket, the stopper is provided on one gasket layer and the component support element is provided on another gasket layer;

(ii) a gasket layer provided with at least one component support element is also provided with at least one sealing bead (associated with a media passage opening);

(iii) the at least one component support element is formed by a stamping of a gasket layer which forms at least one protrusion protruding beyond this gasket layer (the production of a component support element of this kind is usually simpler and more economical than that of a component support element having the form of a support pad fixedly attached to a gasket layer);

(iv) a stopper is provided on one side (that is to say the main surface) of a gasket layer, and the component support element is provided on the other side (that is to say the main surface) of this gasket layer, wherein the stopper and the component support element, as viewed in a plan view of the gasket layer, are at least substantially opposite one another (if the component support element is produced by stamping of the gasket layer, it is recommended to perform this stamping process before the gasket layer is provided with the stopper).

A flat gasket according to the invention, the stopper of which is provided with a height profile which has large height differences, enables a relatively problem-free manufacture whilst at the same time satisfying at least some of the above-mentioned requirements of a flat gasket (installation thickness, low sealing gap dynamic as considered overall, limitation of the flattening of the sealing bead, and at least reduction of shifting of the bead working point) in that the height profile of the stopper required theoretically in order to satisfy these requirements is divided up or distributed so to speak between the stopper on the one hand and the at least one component support element on the other hand. An advantageous embodiment of this kind of the flat gasket, in which the stopper is provided with a height profile of which the height, based on the plane defined by the gasket layer provided with the stopper, varies in the peripheral direction of the media passage opening associated with the stopper or in the longitudinal direction of the stopper, is characterized in that a theoretical height profile of the stopper necessary for evening out the compression is replaced by a combination of an actual height profile of the stopper and the at least one component support element, this combination having the same effect as the theoretically necessary height profile.

An advantageous embodiment of this kind of the flat gasket is preferably configured such that the height of the height profile of the stopper in at least one longitudinal portion of the stopper varies between a maximum value Hₘₐₓ in at least one first longitudinal portion region and a minimum value Hₘᵢₙ in at least one second longitudinal portion region of this stopper longitudinal portion by a height difference ΔH=Hₘₐₓ−Hₘᵢₙ, wherein the actual height of the stopper height profile in the first longitudinal portion region is reduced, compared to a theoretical height of the stopper height profile necessary for evening out the compression, by at most ΔH/2, and wherein, in the first longitudinal portion region of the stopper, the reduction of the height of the stopper height profile is compensated by at least one component support element provided over the first longitudinal portion region of the stopper.

As is clear from the above explanations of the present invention, preferred embodiments of the invention in which the height profile of the unit consisting of stopper and component support element is not divided up or distributed between the stopper and the at least one component support element are characterized in that the stopper has the same height or thickness everywhere and a locally greater effective height of this unit is achieved only by the at least one component support element.

A flat gasket in accordance with the above-defined advantageous embodiments with a stopper having a height profile can also be produced economically when the stopper itself is provided with its actual height profile by means of a stamping process.

As already mentioned, embodiments in which at least the gasket layer or gasket layers which is/are provided with the sealing bead and/or the stopper and/or the component support element extends/extend over the entire flat gasket are preferred for a flat gasket according to the invention.

Since the present invention has particular significance in the field of cylinder head gaskets, a flat gasket according to the invention is configured in particular as a cylinder head gasket for a reciprocating internal combustion engine. In addition, the invention has a particularly advantageous effect on those regions of cylinder head gaskets which, as media passage opening, contain a combustion chamber opening (associated with an engine cylinder). A seal must be provided around a combustion chamber opening of a cylinder head gasket against the highest media pressures, specifically against the gas pressures occurring during engine operation, and therefore, at least in most cases, a cylinder head gasket is configured such that, when the cylinder head gasket is in the installed, i.e., compressed state, the highest compression forces act on those gasket regions which surround a combustion chamber opening.

The invention also relates to a sealing assembly comprising a substantially metallic flat gasket clamped between components, wherein at least one of the components has at least a locally different component stiffness (in the direction perpendicular to the plane defined by the flat gasket) and the flat gasket has at least one media passage opening, screw holes for the passage of the mounting screws used to clamp the flat gasket, and at least one gasket layer at least around the media passage opening, and wherein at least one gasket layer is provided with a sealing bead surrounding the media passage opening, and at least one gasket layer, specifically the gasket layer provided with the sealing bead or another gasket layer for limiting the deformation of the sealing bead, is provided with a stopper (at least one stopper), which surrounds the media passage opening at least substantially (specifically completely or except for at least one gap), and wherein the flat gasket has means for evening out the compression of the stopper of the installed flat gasket (that is to say the compression forces acting on the stopper) along the length of the stopper.

In accordance with the configuration and effect of a flat gasket according to the invention, a sealing assembly of this kind is configured in accordance with the invention such that the means for evening out the compression of the stopper along the length of the stopper comprise at least one component support element, which is arranged opposite a region of a component (that is to say is arranged above or below this component region in a plan view of the flat gasket) in which this component has a lower component stiffness compared to component regions immediately adjacent to this component region (compared to the stiffness of the immediately adjacent component regions), and which, in a plan view of the flat gasket, is provided (preferably only) above or beneath a longitudinal portion of the stopper and is configured such that, in the region of this stopper longitudinal portion, the flat gasket is locally thicker than in regions of stopper longitudinal portions immediately adjacent to this stopper longitudinal portion.

Preferred embodiments of a sealing assembly according to the invention have one or more of the features of the flat gasket according to the invention which have been described above as optional features of the flat gasket.

The present invention can also be applied advantageously to what are known as backland supports of substantially metallic flat gaskets. A backland support is understood by a person skilled in the art to mean a component support which is arranged at a spacing from the sealing system associated with a media passage opening or at a spacing from the media passage openings provided with sealing systems. In the case of a flat gasket, particularly a cylinder head gasket, a backland support or backland supports is/are used usually for the purpose of avoiding undesirably excessive deformations of at least one of the components receiving the flat gasket between them at the time of assembly and during operation of the flat gasket, in particular for compensating for relatively large distortions of at least one of these components, and/or relatively large deformations of regions, in particular in at least one region of the sealing face facing the flat gasket, of at least one of these components in the event that, in a region of this kind, the component has a much lower component stiffness than in a component region adjacent to this region. In the case of a cylinder head gasket that is to be clamped between the components constituted by the engine block and cylinder head, the above is true particularly for the cylinder head, the component stiffness of which is generally lower than that of the engine block. In the case of elongate flat gaskets and consequently elongate components receiving the flat gasket between them, backland supports of this kind are provided in particular in the longitudinal end regions and/or in the vicinity of at least one longitudinal edge of the flat gasket. This is true in particular for cylinder head gaskets for multi-cylinder engines, whether what are known as straight engines or what are known as V engines (having two so-called cylinder banks, each of which accommodates a plurality of cylinders).

These backland supports are thickened portions of a gasket layer or a plurality of gasket layers of the flat gasket, wherein a thickened portion of this kind in particular has the form of a support pad on a gasket layer or a stamping of the gasket layer forming at least one protrusion. Here, it can be advantageous to provide the backland support with a height profile, and then at least some of the problems described above for a stopper will be encountered in respect of the backland support.

A backland support therefore at least primarily is not a deformation limiter for a sealing bead, as is the case with a stopper, but instead is at least primarily an element by means of which deformations of at least one of the components receiving the flat gasket between them are at least reduced and/or compensated for, and which also does not always have to be adjacent to or associated with a media passage opening.

The present invention thus also relates to an at least substantially metallic flat gasket which is configured in particular as a cylinder head gasket and which is clampable between sealing faces of components facing towards one another and which has a gasket plate provided with at least one first and at least one second media passage opening and screw holes for the passage of mounting screws used to clamp the flat gasket, which gasket plate has at least one gasket layer provided with at least one first media opening corresponding to a first media passage opening of the gasket plate, a sealing device for the at least one first media passage opening, and at least one component support device, wherein, in a plan view of the flat gasket, the component support device is arranged in what is known as the backland, i.e., on the side of the sealing device facing away from the at least one first media passage opening and at a spacing from the sealing device.

In accordance with the invention the component support device has at least one elongate first support element (in a plan view of the flat gasket) and at least one second support element, wherein this second support element, in a plan view of the flat gasket, is provided only over a longitudinal portion of the first support element and is configured such that the flat gasket, in particular the clamped and thus compressed flat gasket, is locally thicker in the region of this second support element than in regions of longitudinal portions of the first support element immediately adjacent to this second support element.

In a plan view of the flat gasket, the first support element is thus configured such that its first dimension measured along the support element is greater than its second dimension measured transversely hereto, and in particular the first dimension is a multiple of the second dimension.

If flat gaskets according to the invention provided with a backland support are compared with flat gaskets according to the invention that have a stopper and a component support element associated therewith, it is clear that, in the case of the first-mentioned flat gasket, the first support element thereof is provided at the location of a stopper and the second support element thereof is provided at the location of a component support element of the second above-mentioned flat gasket, and moreover these are located at locations of the flat gasket other than where the unit formed of stopper and component support element are located.

The following shall be noted with regard to the above definition of a flat gasket according to the invention with a backland support:

In a plan view of the flat gasket, the elongate first support element does not, under any circumstances, have to run in a straight line; rather, it can have a curved form, even at least in regions, in a plan view of this kind, and for example can have a form corresponding approximately to a C or L shape.

A flat gasket according to the invention provided with a backland support, as is the case for the at least one first media passage opening, can also be provided with a sealing device for the at least one second media passage opening.

If, in the case of a flat gasket according to the invention provided with a backland support, it is necessary to provide a seal around the at least one first media passage opening with respect to particularly high media pressures, as is the case with a combustion chamber opening of a cylinder head gasket, the components receiving the flat gasket between them are generally well supported by the sealing device provided for this media passage opening, particularly when the sealing device has a sealing bead provided in a gasket layer and a stopper associated with said sealing bead and providing the component support. Since cavities provided in the components receiving the flat gasket between them communicate with one another through the at least one second media passage opening and the component stiffness of the components is locally reduced as a result of these cavities, a backland support formed by the first and the second support element is used in particular to compensate for locally reduced component stiffness of this kind.

Consequently, preferred embodiments of a flat gasket according to the invention provided with a backland support are characterized in that at least one component support device (in a plan view of the flat gasket) is arranged immediately adjacent to at least one second media passage opening. In particular in the case of a cylinder head gasket the at least one second media passage opening is a liquid passage opening.

If a flat gasket according to the invention provided with a backland support has at least two gasket layers around the first and second media passage openings, it is advantageous to provide at least the first support element on a first of these gasket layers, wherein the second support element is then provided preferably on a second of these gasket layers.

For reasons of efficacy both of the first and second support element, it is generally preferred to arrange the aforementioned first and the aforementioned second gasket layer directly one above the other in the gasket plate of the flat gasket. In principle, however, a further gasket layer can also be arranged between the first and the second gasket layer if the flexibility of said further gasket layer does not significantly compromise the efficacy of either one of these two support elements.

Of the first and second support element, the one can have the form of a support pad on a gasket layer (which is most preferred), and the other can be formed by a stamping of another gasket layer, such that this stamping forms at least one protrusion, which protrudes beyond a region of the gasket layer provided with the stamping immediately adjacent to the stamping. However, both support elements can also be formed by support pads or stampings.

Although the at least one second support element on its own means that a component support device formed by the first support element and at least one second support element has a height profile, it can be recommended to provide at least one of the first and second support elements themselves with a height profile, the height of which, based on a plane defined by the flat gasket or gasket plate thereof, varies along the longitudinal first support element, so as to optimally allow for locally different components stiffnesses and/or locally different clamping and thus compression forces acting on the installed flat gasket.

It should also be mentioned that, in the case of a flat gasket according to the invention provided with a backland support, this flat gasket can advantageously have further features with regard to its component support device or first and second support elements, which further features have been mentioned above and/or will be mentioned hereinafter and/or in the accompanying claims for a unit formed of a stopper and a component support element.

Lastly, the present invention also relates to a sealing assembly comprising a substantially metallic flat gasket, which is clamped between components and in particular is configured as a cylinder head gasket, wherein at least one of the components, in the direction perpendicular to the plane defined by the flat gasket, has a locally different component stiffness and the flat gasket has at least one first and at least one second media passage opening, screw holes for the passage of mounting screws used to clamp the flat gasket, a sealing device for the at least one first media passage opening, and at least one component support device, wherein, in a plan view of the flat gasket, the component support device is arranged on the side of the sealing device facing away from the at least one first media passage opening, at a spacing from the sealing device.

In accordance with the invention a sealing assembly of this kind is characterized in that the component support device is opposite a region of a component in which this component has a lower component stiffness compared to component regions immediately adjacent to this component region (in a plan view of the sealing assembly), and in that the component support device has at least one elongate first support element (in a plan view of the flat gasket) and at least one second support element, which (again in a plan view of the flat gasket) is provided only over a longitudinal portion of the first support element and is configured such that the assembled flat gasket, that is to say installed and thus also acted on by compression forces, is locally thicker in the region of this second support element than in regions of longitudinal portions of the first support element immediately adjacent to this second support element (in a plan view of the flat gasket).

The feature of the above-mentioned greater thickness, in this instance, also must not be interpreted so narrowly as to mean the sum of materials of the flat gasket, since the flat gasket for example also has a greater thickness where a gasket layer is provided with a stamping of the above-mentioned type. In addition, in particular the locally greater thickness of the installed, i.e., compressed flat gasket in the region of a component support element or a component support device is of significance for each embodiment of the present invention.

The prior art and preferred embodiments of the invention will be described hereinafter with reference to the accompanying drawings; here, the invention is explained with reference to flat gaskets configured as cylinder head gaskets. However, further features, advantages and details of the invention, which can also be applied to flat gaskets of other kinds, as is clear to a person skilled in the art, shall become clear from the accompanying drawings and the description below.

### BRIEF DESCRIPTION OF THE DRAWINGS

FIG. 1 shows a section through a region of a sealing assembly of a reciprocating internal combustion engine, wherein this sealing assembly comprises the engine block, the cylinder head, and a cylinder head gasket of conventional configuration arranged between these components;

FIG. 2 shows a plan view of a cylinder head gasket according to the invention;

FIG. 3 shows a section through this cylinder head gasket in accordance with line 3-3 in FIG. 2;

FIG. 4 shows a section through the cylinder head gasket along line 4-4 in FIG. 2;

FIG. 5A shows a section through the cylinder head gasket along line 5-5 in FIG. 2;

FIG. 5B shows a plan view of the left-hand part of the cylinder head gasket according to FIG. 2, wherein FIG. 5B however is a schematic illustration of two gasket layers of the cylinder head gasket arranged one above the other, one of which is provided with stoppers associated with combustion chambers of this cylinder head gasket and the other of which is provided with component support elements according to the invention;

FIG. 5C shows a schematic illustration of a region of a gasket layer of a flat gasket according to the invention, more specifically in an oblique view, wherein this gasket layer can correspond to the gasket layer shown on the left in FIG. 5A and the region of the gasket layer shown in FIG. 5C contains a sealing bead surrounding a media passage opening and also a first embodiment of a component support element;

FIG. 5D shows a schematic sketch of the unit formed of stopper and component support element arranged thereabove in order to explain a height profile of this unit;

FIG. 6 shows an illustration, corresponding to FIG. 5C, of a region of a gasket layer with a second embodiment of a component support element according to the invention;

FIG. 7A shows an oblique view of a region of a gasket layer containing only a third embodiment of a component support element according to the invention;

FIG. 7B shows a section along the line 7B-7B in FIG. 7A;

FIG. 8A to 8D show sectional illustrations corresponding to the sectional illustration of the cylinder head gasket in FIG. 1 through various embodiments of a flat gasket according to the invention;

FIG. 9A shows sketches for explaining a first basic principle of the invention with reference to a flat gasket corresponding to FIG. 8A;

FIG. 9B shows a sketch, corresponding to the right-hand part of FIG. 9A, for explaining a second basic principle of the invention;

FIG. 10A shows sketches, corresponding to FIG. 9A, of a variant of the invention;

FIG. 10B shows a sketch, corresponding to FIG. 5D, of the embodiment shown in FIG. 10A;

FIGS. 11A and 11B show sketches corresponding to FIGS. 10A and 10B for a further variant of the invention;

FIG. 12 shows a plan view of part of a flat gasket according to the invention provided with a backland support, more specifically the right-hand lower part of FIG. 2 on an enlarged scale and supplemented by a backland support;

FIG. 13 shows a section along line 13-13 in FIG. 12; and

FIG. 14 shows a graph, corresponding to FIG. 9B, in which height profiles of the support elements of the component support device shown in FIG. 12 are shown.

### DETAILED DESCRIPTION OF THE INVENTION

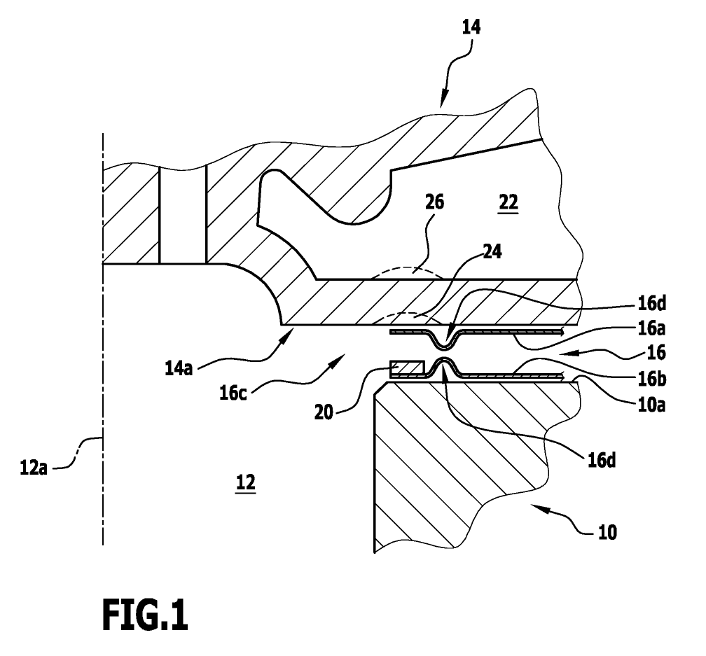

FIG. 1 shows an axial section through regions of various parts of a reciprocating internal combustion engine, specifically through a region of an engine block 10, which surrounds a combustion chamber of at least one cylinder of the engine, wherein only part of a combustion chamber 12 of this kind has been shown, the axis of which, that is to say the cylinder axis, has been denoted by 12a. The section also passes through a region of a cylinder head 14 and through a cylinder head gasket 16. FIG. 1 shows the cylinder head gasket 16 in the, as yet, uncompressed state, that is to say prior to the assembly of the cylinder head 14 on the engine block 10, and prior to the tightening, performed at that time, of cylinder head screws (not shown in FIG. 1).

For the sake of simplicity, the cylinder head gasket 16 has been shown with two gasket layers 16a and 16b, each of which has an opening corresponding to the combustion chamber 12, wherein these openings in the two gasket layers are arranged in particular congruently one above the other (as viewed in the direction of the cylinder axis 12a) and together form a combustion chamber opening 16c of the cylinder head gasket. Each of the two gasket layers 16a, 16b is additionally provided with a combustion chamber sealing bead 16d, which surrounds the combustion chamber opening 16c in a closed manner, that is to say without gaps.

When the cylinder head 14 is in the assembled state and the cylinder head screws have been tightened, the cylinder head gasket 16 is pressed between sealing faces 10a and 14a of the engine block 10 and the cylinder head 14, wherein the combustion chamber sealing beads 16d are pressed against one another by means of their crests and the height of the combustion chamber sealing beads measured in the vertical direction in accordance with FIG. 1 is reduced spring-elastically (as is conventional in the case of metallic flat gaskets, gasket layers provided with sealing beads, and therefore the gasket layers 16a and 16b, are made of sheet spring steel).

In the case of metallic flat gaskets having one or more gasket layers, a gasket layer provided with a bead that can be flattened spring-elastically is usually referred to as a functional layer.

So that the sealing beads 16d are not excessively deformed, that is to say flattened, when the cylinder head gasket 16 is assembled and during gasket operation, which could be detrimental to the durability of the beads, the cylinder head gasket 16 is provided, as is usual, with at least one deformation limiter for the sealing beads. A deformation limiter of this kind is usually referred to as a stopper, and will be referred to in this way hereinafter. In the case of the cylinder head gasket 16 shown in FIG. 1, the stopper denoted by 20 is arranged on the lower gasket layer 16b, surrounds the combustion chamber opening 16c in a circular ring-shaped manner, and for example has the form of a sheet-metal ring, which is attached to the lower gasket layer 16b in particular by welding. Just like any stopper, the stopper 20 must also be configured and made of a material such that it is resistant to deformation caused by the compression forces occurring as the cylinder head gasket 16 is assembled and during gasket operation (forces acting in the vertical direction in accordance with FIG. 1), and such that its height changes insignificantly at most.

In addition, the effective height of the stopper 20 must be such that, as the cylinder head gasket 16 is assembled, that is to say as the gasket is clamped, the height of the combustion chamber sealing beads 16d is indeed reduced slightly, but the sealing beads are not flattened to an undesirable extent.

Many other embodiments of stoppers of this kind are known from the prior art, for example stoppers formed from material applications, such as stoppers sintered from powder that can be sintered, but also stamped stoppers, that is to say stoppers which are formed in that the sheet metal of one or both gasket layers is provided with stamped protrusions.

It should also be noted additionally with regard to FIG. 1 that, when the cylinder head gasket 16 is in the installed and compressed state, the stopper 16 forms a deformation limiter for the combustion chamber sealing beads 16d of the two flexible gasket layers 16b.

The engine components formed by the engine block and cylinder head usually have relatively large cavities, more specifically also in the vicinity of the cylinder combustion chambers. Usually, cooling water flows through these cavities, or these cavities are used to return engine oil from the cylinder head into the engine block and into an oil sump arranged beneath the latter. A cavity of this kind leads to a locally lower stiffness of the engine component provided with the cavity, in particular in the case of a cylinder head, since the cylinder heads of modern engines are produced from lightweight metal alloys. FIG. 1 shows part of the cavity 22 of this kind, which is a cooling water cavity. This understandably leads to a reduction of the stiffness of the engine component, that is to say of the cylinder head 14, more specifically not only in the region of the cavity, but also in the vicinity of the cavity. Since a seal with respect to particularly high media pressures, specifically the peak pressures of the ignited combustion gases, must be provided by a cylinder head gasket around the cylinder combustion chambers, the compression forces acting on an installed cylinder head gasket are concentrated particularly on the regions of the cylinder head gasket surrounding the cylinder combustion chambers, such that locally lower stiffnesses of the engine components in the vicinity of these gasket regions have relatively large effects, specifically a local reduction of the compression forces acting on the regions of the cylinder head gasket surrounding the cylinder combustion chambers. This will be explained with reference to FIG. 1.

If the cylinder head 14 is assembled and the cylinder head screws clamping the cylinder head against the engine block 10 are properly tightened, the reaction forces, particularly of the stopper 20, acting on the cylinder head 14 lead, without particular measures, to a local deformation of the regions of the engine components arranged above and beneath the stopper 20, particularly of the cylinder head, as has been indicated in FIG. 1 by dashed lines—see the inward bulging 24 and the outward bulging 26 of the cylinder head 14, which surround the combustion chamber 12 approximately in a circular ring-shaped manner, wherein the depth or height of the inward or outward bulging can vary around the combustion chamber 12. The local deformation of the cylinder head 14 could indeed be counteracted for example by providing the cylinder head with a support bead in the region of the cavity 22 above the stopper 20, however the production of the cast part forming the cylinder head would be made more complicated.

Since the layers of a metallic flat gasket, but particularly the gasket layers 16a, 16b made of sheet spring steel and configured as functional layers, are flexible, the annular region of the cylinder head gasket 16 defined by the stopper 20, as the cylinder head gasket 16 is assembled, that is to say as the cylinder head screws are properly tightened, dips into the resultant inward bulging 24 in the sealing face 14a of the cylinder head 14, which in the case of this flat gasket formed in accordance with the prior art leads to a local reduction of the compression forces acting on the flat gasket.

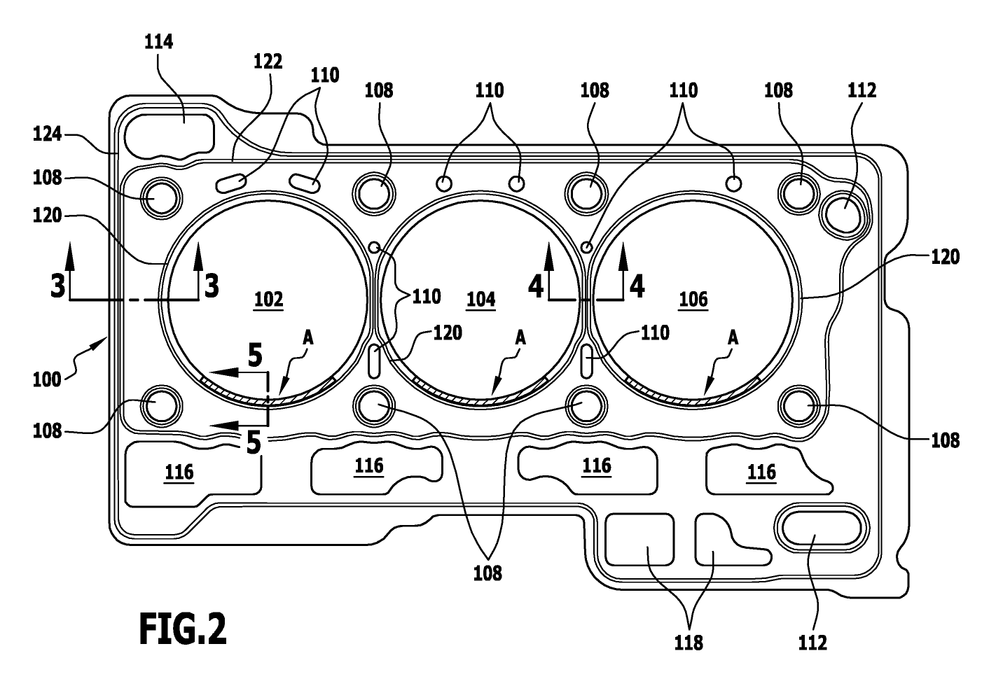

FIG. 2 shows a plan view of a flat gasket according to the invention configured as a cylinder head gasket, which flat gasket for example can be a cylinder head gasket for a 3-cylinder engine or can be a cylinder head gasket for a cylinder bank of a 6-cylinder engine configured as a V engine.

The cylinder head gasket denoted as a whole by 100 has three combustion chamber openings 102, 104 and 106, screw holes 108 for the passage of cylinder head screws, differently configured water holes 110 for the passage of cooling water, differently configured pressure oil openings 112 for the passage of engine oil conveyed under pressure into a cylinder head, and differently configured oil return openings 114, 116 and 118 for the pressure-free return of engine oil from the cylinder head through an engine block into an oil sump of the engine.

A seal is provided around the combustion chamber openings 102, 104, 106 by means of combustion chamber sealing beads 120, and when the cylinder head gasket is in the installed state with gasket regions flooded by cooling water, a seal is provided on the one hand with the aid of the combustion chamber sealing beads 120 and on the other hand with water sealing beads 122, and lastly a seal is provided at the periphery of the cylinder head gasket 100 by means of peripheral sealing beads 124.

As can be seen clearly from FIG. 2, a series of relatively large oil return openings 116, by means of which oil channels of accordingly large cross-section used to return oil in the engine block and in the cylinder head communicate with one another, are located in the vicinity of the series of combustion chamber openings 102, 104, 106. These oil channels of large cross-section result in local component regions of much lower component stiffness, particularly in the cylinder head, and these regions of locally significantly reduced component stiffness lead to the disadvantageous consequences, described further above in conjunction with FIG. 1, in the adjacent regions of the cylinder head gasket 100 bordering the combustion chamber openings 102, 104, 106, said regions being shown in a hatched manner in FIG. 2 and being denoted by “A”.

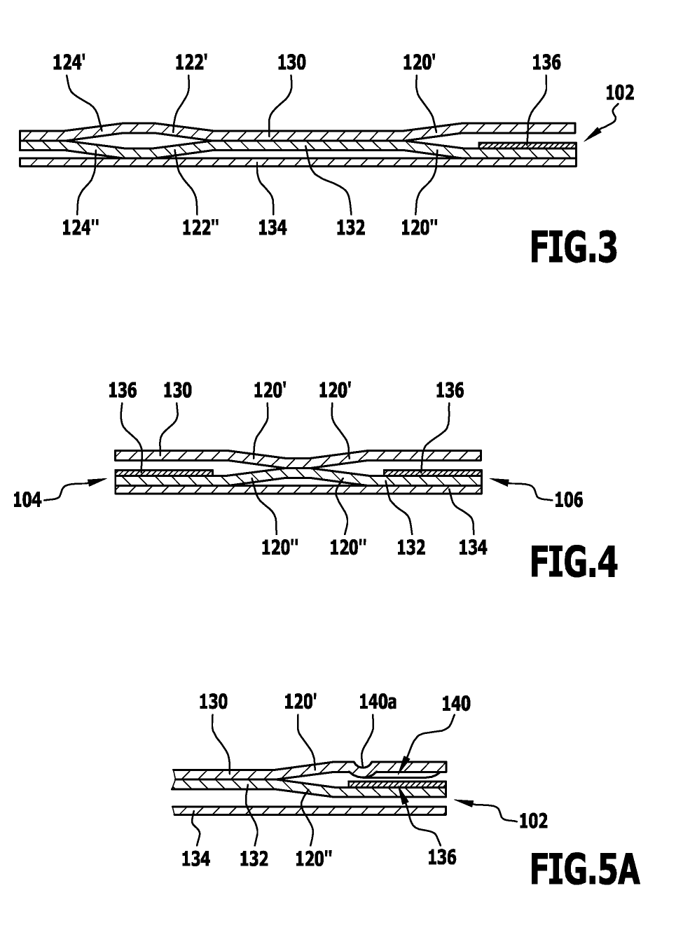

As shown in FIG. 2 in conjunction with the sections, shown in FIGS. 3, 4 and 5A, along the lines 3-3, 4-4 and 5-5 in FIG. 2, the cylinder head gasket 100 has a gasket plate formed by a plurality of gasket layers and for example having three gasket layers, which all extend over the entire cylinder head gasket, specifically two so-called functional layers and a flat third layer. An outer functional layer 130, when the cylinder head gasket is in the installed state, is arranged in particular facing the cylinder head and immediately adjacent to an inner functional layer 132, and an outer flat layer 134, when the cylinder head gasket is in the installed state, is arranged in particular facing the engine block. Whereas the two functional layers 130, 132 are produced from a sheet spring steel, which retains its spring-elastic properties even at the operating temperatures of the cylinder head gasket, the flat layer 134 can be produced from sheet steel, which is less costly.

As can be seen in particular from a comparison of FIGS. 2 and 3, the functions of the combustion chamber sealing beads 120, the water sealing beads 122, and the peripheral sealing bead 124 shown in FIG. 2 are taken on in each case by two sealing beads of the functional layers 130 and 132; the function of the seal of the combustion chamber openings 102, 104, 106 is taken on specifically by, in each case, two beads 120′ and 120″ arranged one above the other and configured as half-beads; the function of the water sealing beads 122 is taken on by two half-beads 122′ and 122″ arranged one above the other, and the function of the peripheral sealing bead 124 is taken on by two half-beads 124′ and 124″ arranged one above the other.

In particular, the combustion chamber sealing beads, in contrast to that shown in FIGS. 3, 4 and 5A, could also be formed as full beads instead of half-beads, as can be seen from FIG. 1. The stopper 136 and the component support element 140 according to the invention in both cases lie immediately next to or in the immediate vicinity of the associated combustion chamber sealing bead.

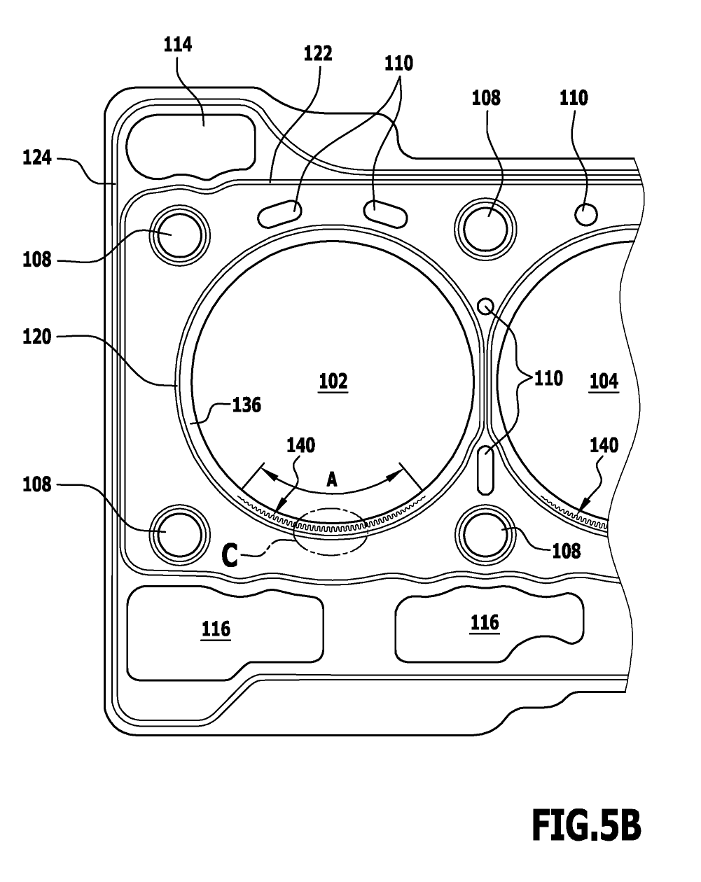

It can be seen from FIGS. 3 and 4 that the combustion chamber openings 102, 104, 106 are each surrounded by a stopper 136, which lies radially inwardly of the combustion chamber sealing beads 120′, 120″ (as considered from the corresponding combustion chamber opening) and is arranged immediately adjacent thereto. In particular, the stopper 136 is immediately adjacent to the corresponding combustion chamber opening and the corresponding combustion chamber sealing beads (in a plan view of the cylinder head gasket). The stopper 136 can be a sheet steel ring, which is attached to one of the two functional layers 130, 132, in particular by a peripheral weld seam, and the thickness of which is such that, when the cylinder head gasket is in the installed and compressed state, said stopper acts as a deformation limiter for both beads 120′ and 120″. The thickness of the stopper 136 must thus be smaller than the sum of the heights of the beads 120′ and 120″, wherein the stopper thickness is such that the two beads 120′, 120″ are not flattened to an undesirable extent when the cylinder head gasket is assembled and during operation thereof, but can follow the operation-induced fluctuations in the height or thickness of what is known as the sealing gap spring-elastically, said sealing gap being formed by the sealing faces of engine block and cylinder head that face one another, and receiving the cylinder head gasket.

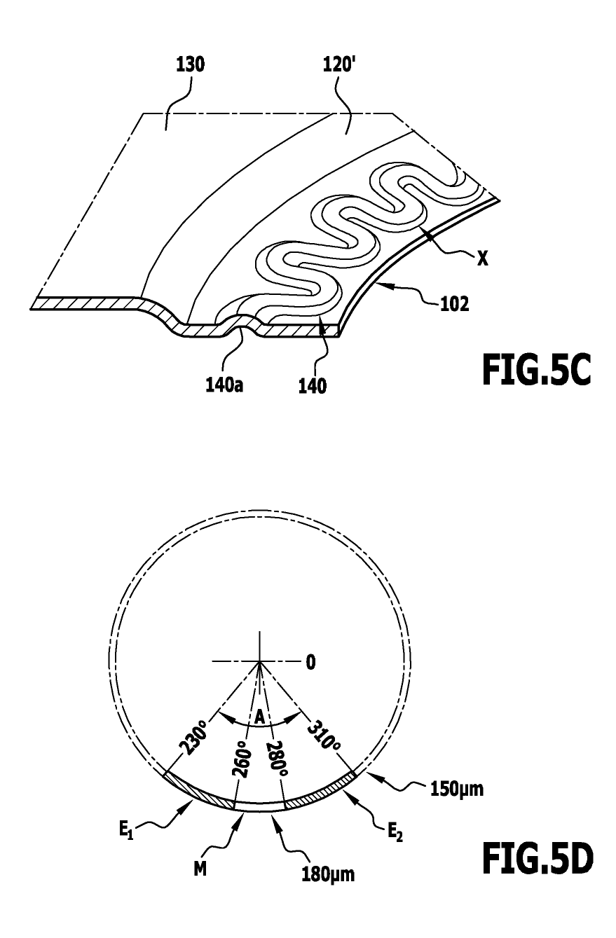

Each of the stoppers 136 is associated, in the region denoted by A in FIG. 2, with a component support element according to the invention, and a component support element of this kind which is formed in accordance with a first embodiment shall be explained by way of example with reference to the section, shown in FIG. 5A, along line 5-5 in FIG. 2.

The functional layer 130 is provided, along the region denoted by A in FIG. 2, above the stopper 136 (to the left of the stopper 136 in accordance with FIG. 5A) with a component support element 140 according to the invention, which extends only along the region A and, in a plan view of the cylinder head gasket, does not protrude beyond the stopper 136 transversely to the longitudinal extent thereof. In the embodiment shown in FIG. 5A, the component support element 140 forms a protrusion protruding over the functional layer 130 in the direction of the stopper 136, however it is also possible in principle for this support element to form a protrusion on the outer side of the cylinder head gasket. For each of these cases, reference is made to the above description of FIG. 1 with regard to the dipping of a region of the cylinder head gasket 16 into the inward bulging 24.

By means of the support element 140 provided only over a longitudinal portion of the stopper 136, the local dipping of the cylinder head gasket into a region of locally lower component stiffness of the cylinder head is compensated for in accordance with the invention.

The embodiment of a component support element according to the invention shown in FIG. 5A corresponds to the component support element shown in FIGS. 5B and 5C, which will be described further below and on which basis the stamping 140a that can be seen in FIG. 5A will be explained.

A preferred embodiment of a component support element according to the invention, such as the support element 140, will be explained hereinafter with reference to FIGS. 5B and 5C.

The region A that can be seen in FIG. 2 for the combustion chamber opening 102 has been marked in FIG. 5B, and the component support element 140 which can be seen in FIG. 5A and which in this case is formed as a bead, stamped from the functional layer 130, with a meandering course (in a plan view of the cylinder head gasket) extends along the longitudinal portion of the stopper 136 extending over the region A.

FIG. 5C shows a region of the functional layer 130 corresponding to the detail C from FIG. 5B.

A bead 140a forming the component support element 140 and having a meandering course in a plan view consists of successive meander curves or loops transitioning into one another, which have the greatest possible “packing density” in the longitudinal direction of the meander form or of the component support element 140, that is to say the limbs of the substantially U-shaped meander regions should follow on from one another with the shortest possible spacings in the longitudinal direction of the component support element 140, so that the component support element is as resistant as possible to deformation, that is to say can counteract the compression forces acting on the component support element when the cylinder head gasket is installed, to such an extent that the component support element is at most insignificantly deformed. To this end, it is also recommended to configure the cross-section of the bead such that the ratio of bead height to bead width is as large as possible or the two lateral flanks of the bead are as stiff as possible.

The meandering bead preferably has a height profile such that the bead height in a middle region of the meander bead is at least substantially constant and in end regions adjoining the middle region decreases preferably continuously in the direction of the bead ends until reaching zero.

It is also recommended to reduce the width of the meander bead in the end regions thereof towards the bead ends, in particular continuously, as can be seen in FIG. 5B.

The position of the stamping 140a that can be seen in FIG. 5A has been denoted by X in FIG. 5C.

The height profile of a preferred embodiment of the unit according to the invention formed of a stopper and a component support element is explained hereinafter with reference to FIG. 5D.

In FIG. 5D the two concentric circles shown by way of dot-and-dash lines are intended to represent a stopper, such as the stopper 136, and a component support element arranged thereabove (in plan view), and in FIG. 5D the region of this unit in which the component support element is provided over a longitudinal portion of the stopper has been denoted again by A.

Since FIG. 5D is intended to explain a unit suitable for FIG. 2, the longitudinal direction of the cylinder head gasket shown in FIG. 2 has been denoted by 0° in FIG. 5D, and the angular region between 180° and 360° faces towards the oil return openings 116. The component support element thus extends over the angular region between 230° and 310°.

In FIG. 5D a middle region of the unit formed of stopper and component support element has been denoted by M, and the end regions adjoining this middle region on both sides and extending as far as the longitudinal ends of the component support element have been shown in a hatched manner and denoted by E₁ and E₂.

The middle region M thus extends over the angular region from 260° to 280°, that is to say over 20°, the end region E₁ extends over the angular region from 230° to 260°, that is to say over an angular region of 30°, and the end region E₂ extends over the angular region from 280° to 310°, that is to say over an angular region likewise of 30°.

For the height profile of the unit formed of stopper and component support element, it has been assumed that the effective height or thickness of the stopper is the same everywhere, that is to say is constant, and only the height of the component support element along the stopper varies. For the effective height of the unit formed of stopper and component support element specified in FIG. 5D, it has been assumed that the height of the stopper, which is identical everywhere, is 150 μm, and the effective height of the component support element varies along the support element between 30 μm and 0 μm (the latter being at both ends of the support element).

In the middle region M, the effective height of the component support element is to be constant and is to have a value of 30 μm, such that in this region the overall height of the unit formed of stopper and component support element is likewise constant and is 180 μm. Starting from the middle region M, the effective height of the component support element should decrease continuously from 30 μm to 0 μm.

This height profile of the unit formed of stopper and component support element proceeds from the consideration, illustrated by FIG. 2, that the component stiffness particularly of the cylinder head is lowest in the regions of the cylinder head arranged at the shortest spacing from the component cavities opening out into the oil return openings 116 and becomes greater with increasing spacing from these cavities.

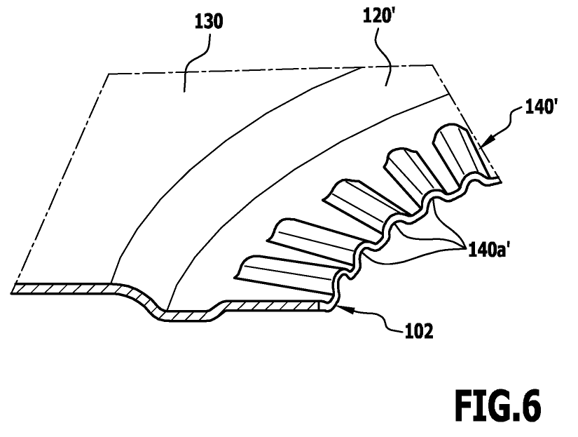

FIG. 6 shows an embodiment of the component support element 140, specifically a component support element 140′, which is modified in comparison with FIG. 3C and which is formed by multiple short, radially extending beads 140a′, which are spaced from one another in the peripheral direction as appropriate.

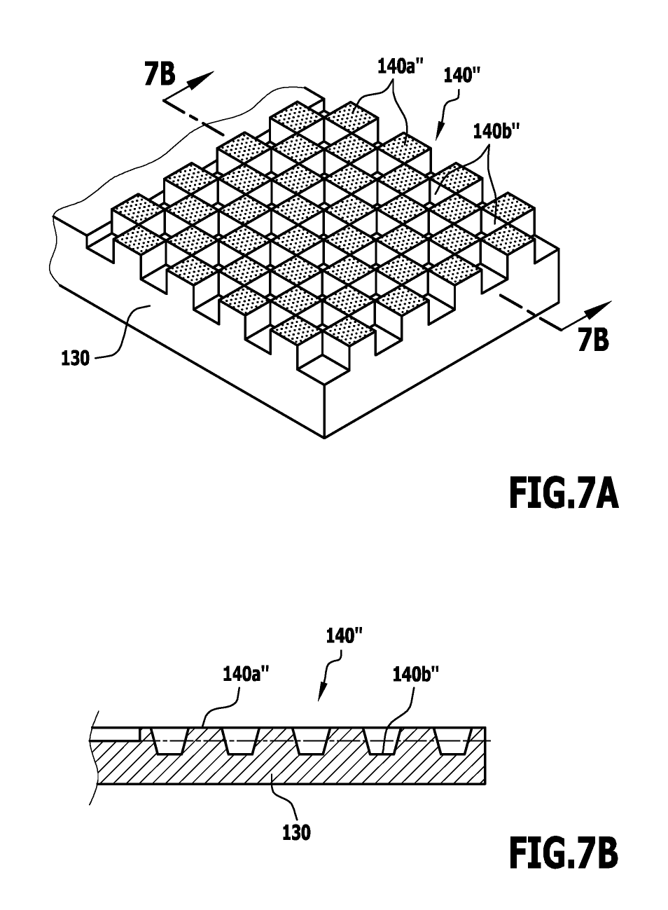

A further embodiment of a component support element according to the invention is shown in FIGS. 7A and 7B, which show small details from a region of the functional layer 130, which is provided with a component support element according to the invention. However, it must be noted that if a flat gasket according to the invention has a structure different from that of the cylinder head gasket shown in the drawings, the component support element could also be provided on another gasket layer as a functional layer, specifically in particular on an at least substantially flat gasket layer, which for example is provided at the position of the functional layer 132, wherein the stopper 136 would then preferably be attached to the functional layer 130.

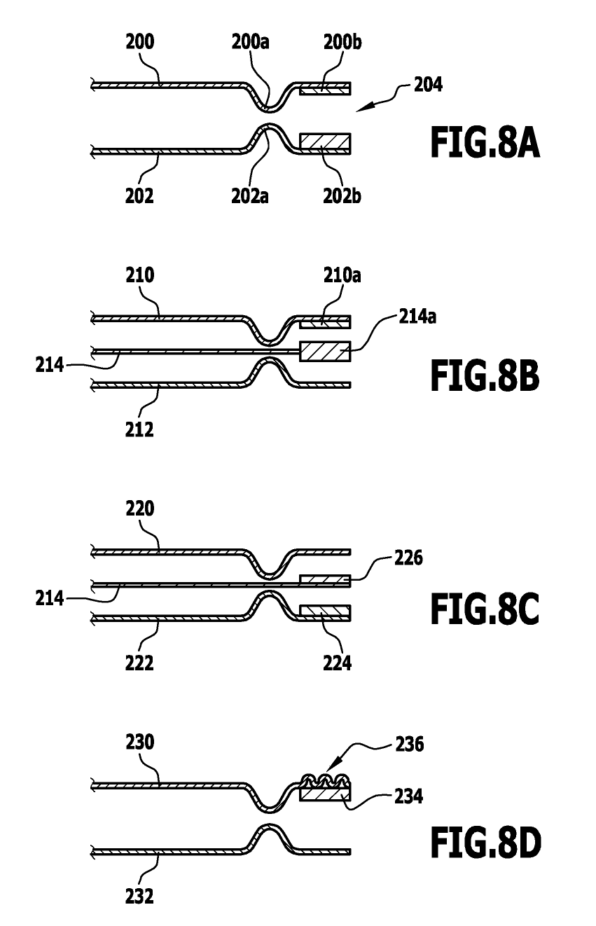

Reference is also made at this juncture to FIGS. 8A to 8D, which are yet to be explained.

In the embodiment according to FIGS. 7A and 7B, the gasket layer 134 forming a component support element 140″ is provided, by way of stamping, with a pattern, in particular a regular pattern, of elevations or protrusions 140a″ and indentations 140b″, wherein the material displaced as the indentations 140b″ are stamped forms the protrusions 140a″. A component support element of this kind is particularly resistant to compression forces as a result of the strain hardening of the steel resulting from the stamping process.

FIGS. 8A to 8D show schematic sectional illustrations of regions of flat gaskets according to the invention having different structures.

FIG. 8A shows regions, arranged one above the other, of two functional layers 200 and 202 with sealing beads 200a and 202a arranged one above the other. In accordance with FIG. 8A, a media passage opening 204 is located to the right of the shown regions of the functional layers 200 and 202, which media passage opening is provided adjacently to the functional layer 202 with a stopper 202b and adjacently to the functional layer 200 with a component support element 200b.

FIG. 8B shows a triple-layer flat gasket having two functional layers 210 and 212 corresponding to the functional layers 200 and 202 of the flat gasket according to FIG. 8A, and also what is known as a stopper layer 214 arranged between the two functional layers, which stopper layer is a flat layer with a stopper 214a. The functional layer 210 is provided with a component support element 210a according to the invention over a longitudinal portion of the stopper 214a.

FIG. 8C likewise shows a triple-layer flat gasket, which corresponds largely to the flat gasket shown in FIG. 8B, but differs therefrom in that what is known as a spacer layer 224 is arranged between two functional layers 220 and 222, which spacer layer is a flat gasket layer. The functional layer 222 is provided with a stopper 224, and the spacer layer 224 has a component support element 226 according to the invention over a longitudinal portion of this stopper.

FIG. 8D shows a two-layer flat gasket, very similar to the flat gasket shown in FIG. 8A, with two functional layers 230 and 232 and a stopper 234 provided on the functional layer 230. The functional layer 230 is provided, over a longitudinal portion of the stopper 234, with a component support element 236 according to the invention produced by stamping of the sheet metal of the functional layer 230, which component support element can be formed as shown in FIG. 5C, 6 or 7A. In the embodiment according to FIG. 8D, a stopper and a component support element are thus provided on the same gasket layer. When producing the flat gasket shown in FIG. 8D, an approach is preferably adopted such that the component support element 236 is firstly stamped and then the stopper 234 is attached to the functional layer 230.

In all of the embodiments shown in FIGS. 8A to 8D, the stopper is likewise to be dimensioned such that it can perform the function of a deformation limiter for the sealing beads of both functional layers (on account of its flexibility).

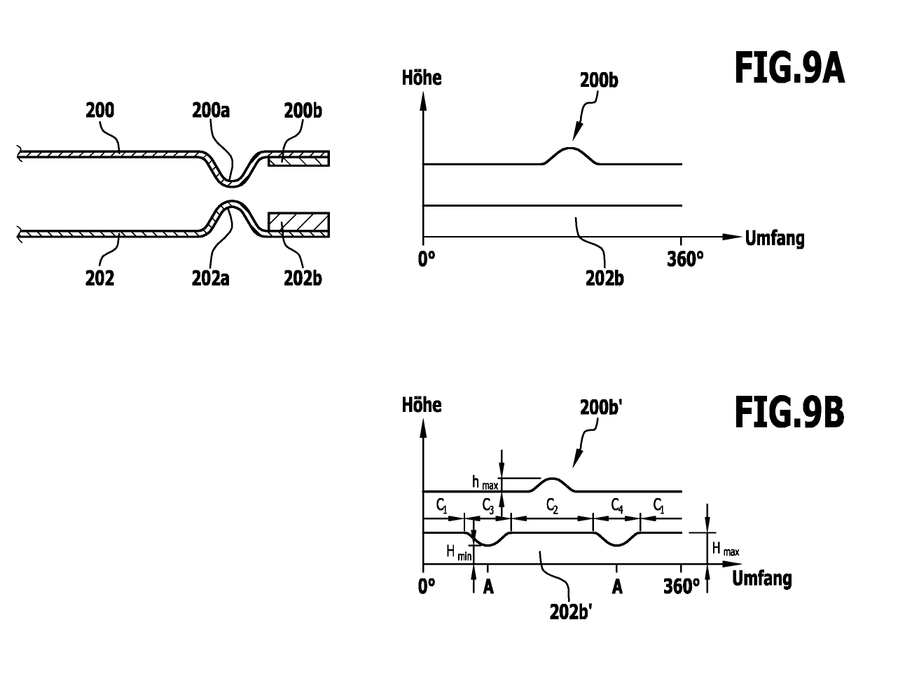

FIG. 8A has been shown again on the left-hand side of FIG. 9A, and in the right-hand part of FIG. 9A a graph is shown, which at the bottom shows a schematic developed view of the stopper 202b over 360° and thereabove shows a developed view of the height profile of the component support element 200b, although this is provided only over a longitudinal portion of the stopper, such that the upper curve of this graph must not be understood in the sense of the component support element extending over the entire periphery of the stopper. In addition, it is clear from a comparison of this graph with the sectional illustration of the cylinder head gasket in the left-hand part of FIG. 9A that although the component support element 200b protrudes downwardly, that is to say in the direction of the functional layer 202, only the total height of the unit formed of the stopper 202b and the component support element 200b is intended to be shown in the graph shown in the right-hand part of FIG. 9A.

The graph shown in the right-hand part of FIG. 9A thus shows, merely qualitatively, that which was described above in conjunction with FIG. 5D, specifically that the effective overall height or thickness of the unit formed of the stopper 202b and the component support element 200b is constant outside the region of the component support element and increases, in the region of the component support element 200b, along the stopper 202b firstly to a maximum, and then decreases again to zero.

FIG. 9B shows a graph corresponding to the graph shown in the right-hand part of FIG. 9A, but relates to another embodiment of the invention. Specifically, whereas in the embodiments corresponding to the graph of FIG. 9A a locally lower stiffness of the components between which the flat gasket is clamped is compensated for merely by a component support element according to the invention, since the associated stopper has the same height or thickness everywhere, in the embodiments of the flat gasket according to the invention corresponding to the graph shown in FIG. 9B the measures for evening out the compression of the unit formed of stopper and component support element are split between these two elements of the flat gasket in that the stopper also has a height profile, specifically a height or thickness that varies along the stopper.

In the graph of FIG. 9B, reference sign 202b′ has been used for the stopper and reference sign 200b′ has been used for the component support element. In addition, two locations on the stopper periphery have been characterized by A on the abscissa of this graph, said locations lying closest to screw holes of the flat gasket for the passage of mounting screws used to clamp the flat gasket.

As is clear from the lower curve of the graph shown in FIG. 9B, the stopper 202b′ has a constant maximum height Hₘₐₓ along its periphery in two first longitudinal portion regions C and C₂, whereas the stopper height varies between Hₘₐₓ and Hₘᵢₙ in two second longitudinal portion regions C₃ and C₄ of the stopper, wherein the stopper 202b′ has its smallest height Hₘᵢₙ at the locations A and the stopper height increases in the longitudinal portion regions C₃ and C₄ on both sides of the respective locations A, more specifically to the value Hₘₐₓ.

In accordance with the invention the maximum height Hₘₐₓ of the stopper 202b′ or height profile thereof is now reduced relative to a theoretical maximum height of the stopper or height profile thereof necessary for evening out the compression, more specifically preferably by at most 50% of the difference between Hₘₐₓ and Hₘᵢₙ, and this reduction of the maximum height of the stopper or its height profile is compensated for by the component support element 200b′ according to the invention, the height profile of which is shown by the upper curve of the graph shown in FIG. 9B.

The graph shown in FIG. 9B is based on the assumption that at least one of the components between which the flat gasket according to the invention is clamped has a reduced component stiffness locally above or beneath the longitudinal portion region C₂ of the stopper 202b′, which reduced component stiffness is to be at least approximately compensated for by the component support element 200b′. So that a blank used for the stopper 202b′ in order to achieve this compensation is not deformed excessively by stamping, that is to say must be provided with a height profile with height differences, the stopper 202b′, in the regions of its locations A located closest to the mounting screws, specifically in its longitudinal portion regions C₃ and C₄, has only relatively few deep stampings with a maximum depth for example of 20 μm, and the component support element 200b′ has a height profile with a maximum height Hₘₐₓ of 30 μm, for example.

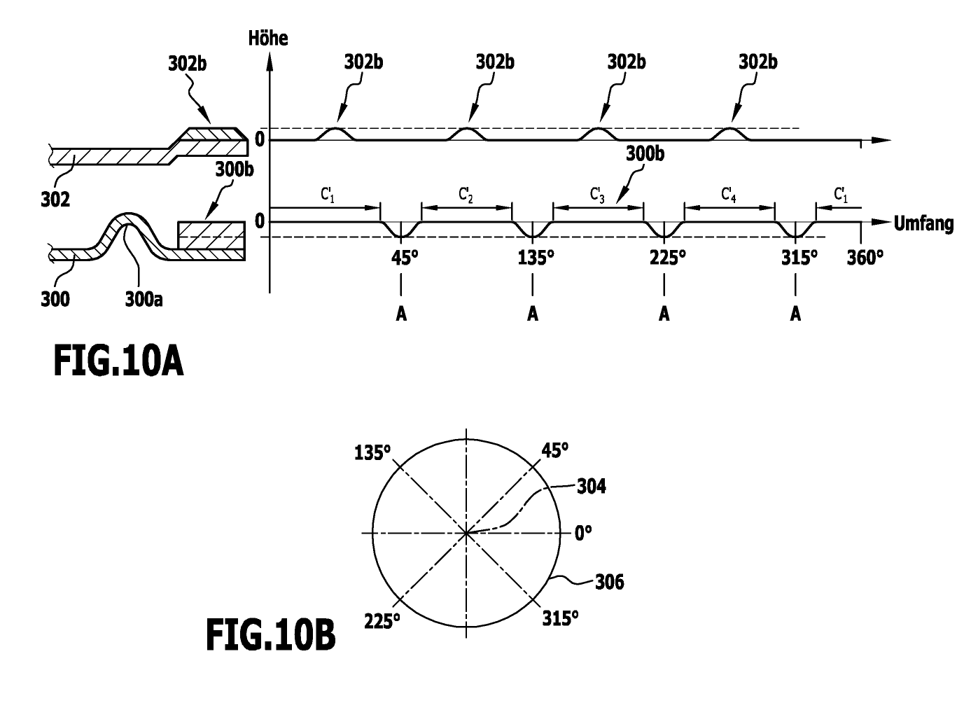

FIG. 10A, on the left-hand side, shows a schematic section similar to FIG. 9A through parts of two gasket layers of a flat gasket according to the invention, and shows a graph on the right, in which a height profile of a stopper is shown schematically at the bottom and the height profiles of a plurality of component support elements according to the invention associated with this stopper are shown schematically at the top. The basic principle of this unit formed of a stopper and component support elements corresponds substantially to the basic principle of the unit, belonging to FIG. 9B, formed of a stopper and a component support element.

The sectional illustration in the left-hand part of FIG. 10A shows part of a gasket layer 300 configured as what is known as a functional layer and part of a further gasket layer 302 which is arranged above this gasket layer part and which is what is known as a spacer layer or what is known as a carrier layer. The gasket layer 302 will therefore be referred to hereinafter as a carrier layer.

The functional layer 300 formed of sheet spring steel is provided with a sealing bead 300a for a media passage opening and also with a stopper 300b, wherein this media passage opening according to FIG. 10A should be arranged to the right of the stopper 300b and should be surrounded by the latter and by the sealing bead 300a. The carrier layer 302, above the stopper 300b, comprises a plurality of component support elements 302b according to the invention arranged in the peripheral direction of the media passage opening at a spacing from one another, which component support elements are formed preferably by protrusions produced by stamping the sheet metal of the carrier layer 302.

FIG. 10B, similarly to FIG. 5D, shows a schematic sketch of a unit formed of a stopper and component support elements associated therewith, wherein this unit is represented merely by a circle, and this sketch serves merely for the purpose of making evident the angular positions of screw holes of a flat gasket according to the invention used for the passage of mounting screws. In FIG. 10B the axis of the aforementioned media passage opening, for example a combustion chamber opening of a cylinder head gasket, is denoted by 304, and the circle representing the unit formed of stopper and component support elements is denoted by 306. The screw holes adjacent to the aforementioned unit are not shown in FIG. 10B, however the angular positions of these screw holes have been indicated, specifically at 45°, 135°, 225°, and 315°.

The embodiment of a flat gasket according to the invention forming the basis of FIGS. 10A and 10B corresponds to the embodiment forming the basis of FIG. 9B, from which the embodiment forming the basis of FIG. 10A differs in that the latter comprises a plurality of component support elements according to the invention.

In the graph shown on the right in FIG. 10A, the height profile of the stopper 300b is shown at the bottom, and the locations on the stopper 300b arranged closest to the screw holes of the flat gaskets are denoted by A along the axis of this graph, specifically at 45°, 135°, 225° and 315° of the developed view of the stopper.

Similarly to the illustration in FIG. 9B, four first longitudinal portion regions of the stopper 300b have been denoted in FIG. 10A by C₁′, C₂′, C₃′ and C₄′, and between these first longitudinal portion regions the stopper 300b has in each case one of a total of four second longitudinal portion regions, in which the stopper is provided in each case with a stamping. In the four first longitudinal portion regions C₁′ to C₄′, the stopper 300b always has the same constant height, specifically its maximum height, whereas in each of the second longitudinal portion regions, which lie between the first longitudinal portion regions C₁′ to C₄′, the height of the stopper varies between its maximum height and a minimum height.

In the graph shown on the right in FIG. 10A, the height profiles of the component support elements 302b according to the invention are shown above the height profile of the stopper 300b, wherein the embodiment of the flat gasket according to the invention for the stopper 300b forming the basis of FIG. 10A comprises four component support elements of this kind, each of which is arranged above one of the first longitudinal portion regions C₁′ to C₄′ respectively.

In the embodiment of the flat gasket according to the invention forming the basis of FIG. 10A, the maximum height of the component support elements 302b is preferably slightly smaller than the maximum reduction of the height of the stopper 300b between the longitudinal portion regions C₁′ to C₄′ thereof. For example, the maximum height of the component support elements 302b is approximately 20 μm, whereas the height of the stopper 300b between the longitudinal portion regions C₁′ to C₄′ thereof has been reduced by at most approximately 30 μm compared to the maximum stopper height.

For the rest, with regard to the embodiment of the flat gasket according to the invention forming the basis of FIG. 10A, reference can be made to the above explanations for FIG. 9B.

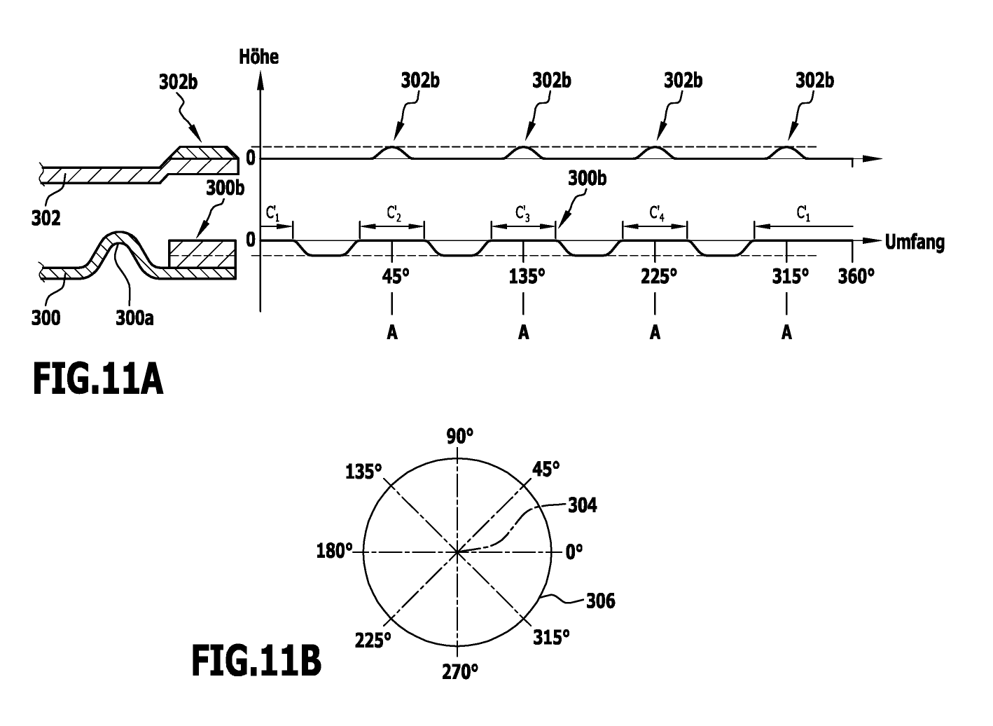

FIGS. 11A and 11B correspond to FIGS. 10A and 10B; although whereas in the embodiment of the flat gasket according to the invention forming the basis of FIG. 10A the height or thickness of the stopper 300b is reduced in the stopper regions arranged closest to the screw holes, an embodiment of the flat gasket in which the height of the stopper is reduced in those stopper regions located between the stopper regions arranged closest to the screw holes forms the basis of FIG. 11A.

In FIGS. 11A and 11B the same reference signs as in FIGS. 10A and 10B have been used, and FIGS. 11A and 11B are also described hereinafter only in the extent to which they differ from FIGS. 10A and 10B.

In the case of the embodiment of the flat gasket according to the invention forming the basis of FIGS. 11A and 11B, the screw holes arranged closest to the stopper 300b are arranged likewise at the angular positions 45°, 135°, 225° and 315° with regard to the axis 304 of the media passage opening (see FIG. 11B), and in the graph of FIG. 11A the locations on the stopper 300b arranged closest to the screw holes have again been denoted by A. As can be seen from the height profile of the stopper 300b shown at the bottom in the graph of FIG. 11A, the stopper has the same constant height or thickness everywhere, specifically its maximum height or thickness, in first longitudinal portion regions C₁′ to C₄′, whereas the stopper height varies between the maximum stopper height and a minimum stopper height in second longitudinal portion regions located between the longitudinal portion regions C₁′ to C₄′. These second longitudinal portion regions of the stopper with varying stopper heights constitute what are known as the inter-screw regions of the stopper, in which the stopper height has been reduced, preferably by stamping of the stopper.

In the graph of FIG. 11A, the positions and height profiles of the component support elements 302b according to the invention are shown above the height profile of the stopper 300b and, similarly to the embodiment of the flat gasket according to the invention forming the basis of FIG. 10A, are arranged above the stopper longitudinal portion regions C₁′ to C₄′ having the greatest stopper height, and their maximum height can be slightly smaller than the maximum depth of the stopper height profile in what are known as the inter-screw regions. For example, the maximum height of the component support elements 302b is approximately 20 μm, whereas the height of the stopper 300b between the longitudinal portion regions C₁′ to C₄′ has been reduced by approximately 30 μm.

In FIGS. 10A and 11A the stopper longitudinal portion region C₁′ has been shown longer than the other longitudinal portion regions C₂′ to C₄′. The lengths of the longitudinal portion regions C₁′ to C₄′, however, are dependent on the position of the screw holes around the media passage opening and therefore can be sized differently accordingly.

In all of FIGS. 9A, 9B, 10A and 11A the height differences in the height profiles of the stopper and the component support elements have been shown in a greatly enlarged manner, since these height differences cannot otherwise be illustrated, because they lie in the order of magnitude of a hundredth of a millimeter or a few hundredths of a millimeter.

In addition, reference is made again, particularly in respect of FIG. 5A, to the fact that, as a result of the small sheet-metal thicknesses of gasket layers of metallic flat gaskets and the flexibility of these sheet steel gasket layers, the regions of a flat gasket according to the invention provided with a stopper and a component support element according to the invention, at the time of assembly and operation of the gasket, can be readily displaced in the direction perpendicular to the gasket plane as a result of the compression forces then acting on the gasket, such that these regions can dip into inward bulgings of a sealing face of a component facing the gasket created as the flat gasket is clamped, even if, as is the case in the embodiment of a flat gasket according to the invention shown in FIG. 5A, the stopper and the component support element according to the invention are arranged within the flat gasket. In this regard, it should also be noted that for example functional layers of cylinder head gaskets are produced from sheet steel having a thickness of 0.20 or 0.25 mm.

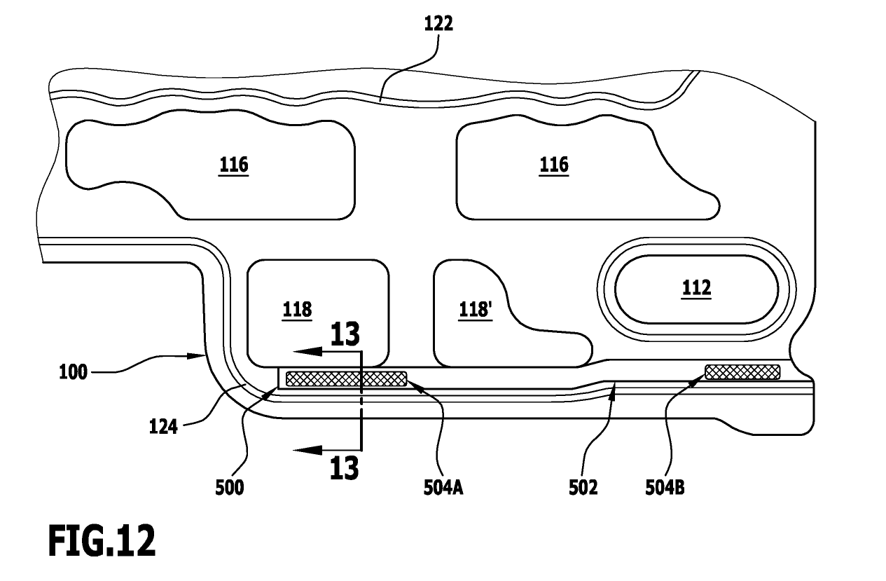

A preferred embodiment of a flat gasket according to the invention provided with a backland support will now be described with reference to FIGS. 12 to 14 and is formed in this case as a cylinder head gasket.

In the detail from FIG. 2 shown in FIG. 12, specifically in the illustration of the right-hand lower region of the cylinder head gasket according to FIG. 2, the same reference signs as in FIG. 2 have been used as far as possible, and the detail from FIG. 2 shown in FIG. 12 will also be described hereinafter only in the extent to which this is necessary to understand a flat gasket according to the invention provided with a backland support according to the invention.

As can be seen from FIG. 12, the cross-sectional area of the left-hand oil return opening 118 according to FIG. 12 is much larger than the cross-sectional area of the oil return opening 118′ arranged on the right next to the oil return opening 118 according to FIG. 12, and the cross-sectional area of said opening 118′ should also be smaller than that of the pressure oil opening 112 shown in FIG. 12.

Since the cavities provided in the components, i.e., in the present case in an engine block and a cylinder head for the engine oil, which communicate with one another by means of the oil openings 118, 118′ and 112 when the engine is in the finished, assembled state and are arranged on either side of the cylinder head gasket, due to their sizes, even if these are different, cause the components receiving the cylinder head gasket between them, specifically the engine block and the cylinder head, to have a significantly reduced component stiffness in their component regions delimiting these cavities, the region of the cylinder head gasket 100 shown in FIG. 12 is provided with a component support device 500 according to the invention, which is arranged in the cylinder head gasket immediately adjacent to the oil openings 118, 118′ and 112 (in a plan view of the cylinder head gasket).

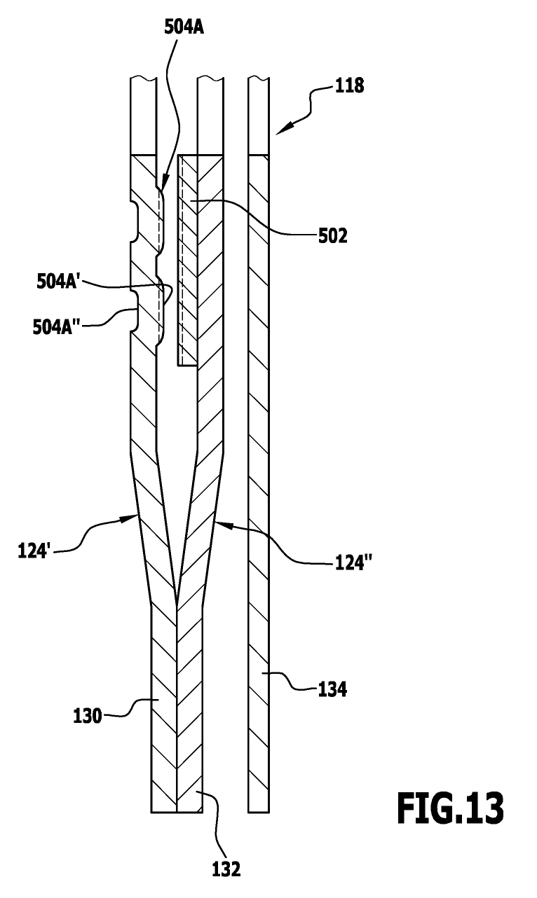

The section shown in FIG. 13 along the line 13-13 in FIG. 12 makes it possible to see, in addition to part of the oil return opening 118, regions, bordering the latter, of the three gasket layers 130, 132 and 134 and half-beads 124′ and 124″, already described above with reference to FIGS. 2 and 3, of the two gasket layers configured as functional layers 130 and 132.

Since FIG. 12 shows a plan view of a region of the cylinder head gasket, in other words the gasket plate thereof, it is obvious that the second media passage openings 112, 116, 118 and 118′ discernible in FIG. 12, in the case of a gasket plate formed by a plurality of gasket layers, are each formed by media openings arranged one above the other in these gasket layers, as can be seen in FIG. 13 for the oil opening 118.

The component support device 500 will now be explained with reference to FIGS. 12 and 13 and in this case is a particularly advantageous embodiment of a component support device according to the invention.

As shown in FIG. 12, the component support device 500 has an elongate first support element 502 and a plurality of, in the present case two, shorter second support elements 504A and 504B, which (in a plan view of the cylinder head gasket) are each provided only over a longitudinal portion of the first support element 502.

A feature of preferred embodiments of the invention is illustrated by FIG. 12 and will be explained hereinafter:

Since the second media passage openings formed by the oil openings 118 and 112 should have larger cross-sectional areas than the oil opening 118′, and since, when the cylinder head gasket is in the installed state, the size of the cavities provided in the engine block and the cylinder head and communicating with one another by means of the oil openings 118, 118′ and 112 have cross sections and cross-sectional areas corresponding to the sizes of the oil openings 118, 118′ and 112, at least in the immediate vicinity of the cylinder head gasket, it can be assumed that in the engine belonging to the cylinder head gasket shown in FIGS. 2 and 12 the component stiffness of the engine block and of the cylinder head (particularly of the cylinder head) in the immediate vicinity of the oil openings 118 and 112 is lower than in the immediate vicinity of the smaller oil opening 118′.

The illustrations in FIGS. 12 to 14 are therefore based on the assumption that, as a result of the component support device 500 according to the invention, the components constituted by the engine block and cylinder head, when the engine is assembled, specifically when the cylinder head screws are tightened, have to be biased (against one another and against the cylinder head gasket) by the component support device 500 in the immediate vicinity of the larger oil openings 118 and 112 to a greater extent than in the immediate vicinity of the smaller oil opening 118′, in order to avoid, to the greatest possible extent, undesirably excessive deformations in particular of the cylinder head, and also an undesirably high dynamic of the sealing gap in the region of the larger oil openings 118 and 112 during engine operation. The component support device 500 according to the invention therefore comprises a second support element 504A or 504B merely in the immediate vicinity of the oil openings 118 and 112, and a second support element of this kind or second support elements of this kind provides/provide the great advantage for the production of the gasket according to the invention that relatively great height differences or differences in the thickness of the component support device can be produced along the elongate component support device 500 according to the invention, which differences cannot be produced, or can be produced only with difficulty by stamping of a metallic component of the flat gasket or cylinder head gasket.

In the embodiment of the invention illustrated in FIG. 13, the elongate first support element 502 is formed by a strip-like and preferably metallic support pad on a gasket layer, in the present case the functional layer 132, whereas the shorter second support element 504A is formed by a stamping of another gasket layer, in the present case of the functional layer 130. In order to form a stamped support element of this kind, a gasket layer of the flat gasket can be stamped in any way, such that the stamping forms at least one protrusion protruding beyond the actual gasket layer, which protrusion is sufficiently resistant to deformation, so as to sufficiently support at least one of the two components receiving the flat gasket between them when the flat gasket is in the installed state. With regard to stampings of this kind, reference is made to FIGS. 5A to 5D, 6 and 7A and 7B and the above explanations for this drawings. FIG. 13 shows an embodiment of a stamping of this kind which, in plan views of the functional layer 130, forms a regular pattern of elevations or protrusions 504A′ and indentations 504A″, wherein the protrusions 504A′ are arranged facing the first support element 502 and, when the flat gasket or cylinder head gasket is in the installed state, are supported on the support element 502. However, the protrusions 504A′ could also be directed away from the first support element 502, although this is not preferred if the gasket layer 130 forms an outer layer of the flat gasket. In addition, the first support element 502 could also be arranged on the side of the gasket layer 132 facing away from the gasket layer 130. Lastly, the flat gasket could have a further gasket layer between the first support element 502 and the second support elements 504A and 504B.

It should also be noted that the first support element 502, instead of a support pad on a gasket layer, could also be formed by a stamping of a gasket layer, and that a support pad on a gasket layer could also be used for a second support element or each second support element.

However, FIG. 13 also makes it clear that the first support element and the at least one second support element could also be provided on the same gasket layer; for example, the gasket layer 132 could be provided with the protrusions 504A′ and the indentations 504A″ by stamping prior to the application of the first support element 502, whereupon the first support element 502 is applied to the gasket layer 132 and is attached thereto, for example by laser welding.

Of course, the flat gasket according to the invention does not have to be provided around the second media passage openings with elastic sealing beads formed in at least one gasket layer; rather, a seal could be provided around the second media passage openings by means of elastomer sealing elements injected onto a gasket layer, as is the case for example with cylinder head gaskets or large engines, when the second media passage openings are passage openings for cooling water or engine oil. Consequently, the half-beads 124′ and 124″ could also be omitted in FIG. 13 if the component support device (502, 504A, 504B) is to perform only a component support function and not also the function of a stopper or deformation limiter for one or more sealing beads (for example the half-beads 124′ and 124″), as is the case in the embodiment shown in FIG. 13. In this case, the sum of the heights of the two half-beads 124′ and 124″ is much greater than the sum of the heights of the first support element 502 and of the protrusions 504A′ or of the corresponding protrusions of the second support element 504B, so that, when the flat gasket or cylinder head gasket is in the installed state and during operation, the sealing beads or half-beads 124′, 124″ can work spring-elastically in the direction perpendicular to the flat gasket plane and, when the flat gasket is assembled, the sealing beads can be somewhat flattened spring-elastically, until a further deformation or flattening is prevented by the support elements.

In the case of a flat gasket according to the invention, the first support element and/or a second support element and/or any second support element can be provided with a height profile, the height of which varies in the longitudinal direction of the elongate first support element.

In the embodiment shown in FIG. 13, this is the case both for the first support element 502 and the second support element 504A or 504B or with both second support elements 504A, 504B. The existence of height profiles of this kind has been indicated in FIG. 13 in that a dashed line has been shown both in the first support element 502 and in the second support element 504A and is intended to represent the deepest point of the particular height profile.

In the case of a flat gasket as is represented by FIG. 12, it is possible by means of height profiles of this kind to allow for the fact, inter alia, that the component stiffness of at least one of the components adjacent to the flat gasket varies along a second media passage opening immediately adjacent to the particular support element.

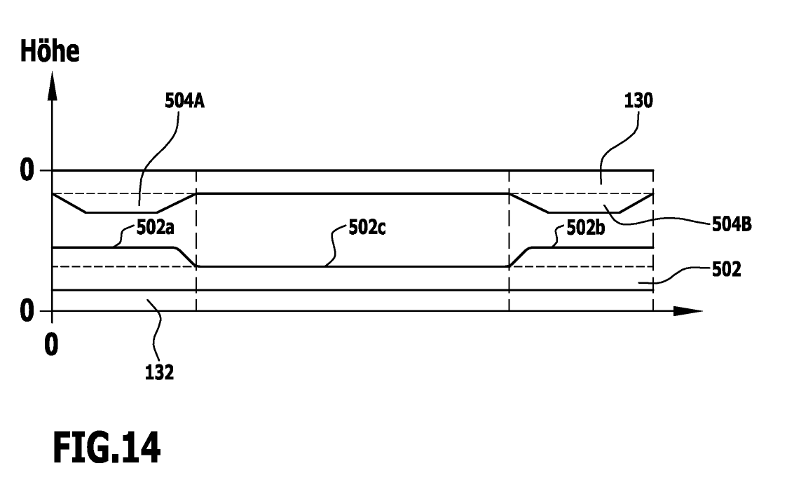

FIG. 14 shows a graph which is intended to show merely schematically the course of the height or thickness of the support elements along the elongate first support element. In this graph the abscissa, that is to say the horizontal axis, represents the length of the elongate first support element or the length of the region of a gasket layer provided with the second support elements, and the ordinate, that is to say the vertical axis, represents the height or thickness of the first support element or of the second support elements.

In order to be able to include the height profiles of all support elements (even if only schematically) in FIG. 14, the graph of FIG. 14 has been provided with two abscissas or zero lines (each characterized by a 0), and in the case of a first support element, which does not strictly run in a straight line in a plan view of the flat gasket, the graph of FIG. 14 is intended to show a developed view of a longitudinal section through the unit formed of the first and at least one second support element and also the associated gasket layers.

Since the graph of FIG. 14 is intended to relate to the embodiment of a flat gasket according to the invention shown in FIG. 13, the same reference signs as in FIG. 13 have been used in FIG. 14 wherever possible.

FIG. 14 firstly shows, above the lower zero line, the part of the gasket layer 132 located beneath the first support element 502, and above this gasket layer the first support element 502, which has a height profile which in the immediate vicinity of the oil opening 118 has a region 502a and in the immediate vicinity of the oil opening 112 has a region 502b, and between the two regions 502a, 502b has an indented region 502c, such that the material strip used for the first support element 502 has to have a reduced thickness, by stamping, primarily only in a relatively short region, specifically in the region 502c.

Since, in the case of the embodiment shown in FIG. 13 the second support element 504A and consequently both second support elements 504A and 504B protrude in the direction of the first support element 502, the gasket layer 130 and the second support elements 504A and 504B are shown schematically beneath the upper zero line in the graph of FIG. 14. FIG. 14 consequently shows the region of the gasket layer 130 which, in a plan view of the flat gasket, is located above the first support element 502, immediately beneath the upper zero line, and beneath the gasket layer 130, again merely schematically, the two second support elements 504A and 504B, wherein each of these second support elements is provided with a height profile.

The dimensions of interest here of a cylinder head gasket according to the invention for engines as are typically used in passenger vehicles preferably lie within the following ranges:

Effective height of the first and/or second support element (i.e., in the case of a stamped second support element, the height of the at least one protrusion produced by stamping): 50 to 150 μm, preferably 60 to 140 μm, and in particular 70 to 130 μm;

Height difference between a level of medium height and the positions of greatest and smallest height of the height profile: 10 to 40 μm, preferably 20 to 30 μm, and in particular 15 to 25 μm.

Lastly, the following should also be noted:

If a gasket layer is subjected to a stamping process in order to form a first or second support element of a component support device according to the invention, this support element can be provided subsequently with a height profile by stamping.

A first or second support element can also be formed by a strip-like region of a gasket layer, in the region of which the material thickness, that is to say the sheet metal thickness of the gasket layer, has been increased in such a way that, from regions of the gasket layer arranged on one side of the strip-like region or on both sides thereof, material is displaced into said strip-like region by extrusion, and the thickness of said region is thus increased. In this case, the support element is indeed the result of a stamping or extrusion process, however the support element is not formed by a multiplicity of discrete protrusions.

1. An at least substantially metallic flat gasket which is clampable between components and which has at least one media passage opening and screw holes for the passage of mounting screws used to clamp the flat gasket, wherein the flat gasket comprises at least one gasket layer at least around the media passage opening, at least one gasket layer with a sealing bead surrounding the media passage opening, and, for limiting the deformation of the sealing bead, at least one gasket layer is provided with a stopper, which at least substantially surrounds the media passage opening, and wherein the flat gasket comprises means for evening out the compression of the stopper of the installed flat gasket along the length of the stopper,
characterized in that the means for evening out the compression comprise at least one component support element which, in a plan view of the flat gasket, is provided only over a longitudinal portion of the stopper and is configured such that, in the region of this stopper longitudinal portion, the flat gasket is locally thicker than in regions of stopper longitudinal portions immediately adjacent to this stopper longitudinal portion.

2. The flat gasket according to claim 1, which has at least two gasket layers at least around the media passage opening.

3. The flat gasket according to claim 1, wherein the component support element is provided on a gasket layer.

4. The flat gasket according to claim 3, wherein the stopper is provided on one gasket layer and the component support element is provided on another gasket layer.

5. The flat gasket according to claim 3, wherein the stopper is provided on one side of a gasket layer and the component support element is provided on the other side of this gasket layer.

6. The flat gasket according to claim 3, wherein a gasket layer provided with at least one component support element is also provided with at least one sealing bead.

7. The flat gasket according to claim 3, wherein the component support element is formed by a stamping of a gasket layer, which forms at least one protrusion protruding beyond the gasket layer.

8. The flat gasket according to claim 1, wherein the stopper is provided with a height profile of which the height, based on the plane defined by the gasket layer provided with the stopper, varies in the peripheral direction of the media passage opening, and wherein a theoretical height profile of the stopper necessary for evening out the compression is replaced by a combination of an actual height profile of the stopper and the at least one component support element, this combination having the same effect as the theoretically necessary height profile.

9. The flat gasket according to claim 8, wherein the height of the height profile of the stopper in at least one longitudinal portion of the stopper varies between a maximum value Hₘₐₓ in at least one first longitudinal portion region and a minimum value Hₘᵢₙ in at least one second longitudinal portion region of this stopper longitudinal portion by a height difference ΔH=Hₘₐₓ−Hₘᵢₙ, wherein the actual height of the stopper height profile in the first longitudinal portion region is reduced, compared to a theoretical height of the stopper height profile necessary for evening out the compression, by at most [symbol] and wherein, in the first longitudinal portion region of the stopper, the reduction of the height of the stopper height profile is compensated by at least one component support element provided over the first longitudinal portion region of the stopper.

10. The flat gasket according to claim 8, wherein the height profile of the stopper is formed by longitudinal portions of the stopper that are stamped in respect of their height.

11. The flat gasket according to claim 1, wherein at least those gasket layers which are provided with the sealing bead and/or the stopper and/or the component support element extend over the entire flat gasket.

12. The flat gasket according to claim 1, which is formed as a cylinder head gasket.

13. The flat gasket according to claim 12, wherein the media passage opening is a combustion chamber opening.

14. A sealing assembly comprising a substantially metallic flat gasket clamped between components, wherein at least one of the components has a locally different component stiffness in the direction perpendicular to the plane defined by the flat gasket and the flat gasket has at least one media passage opening, screw holes for the passage of mounting screws used to clamp the flat gasket, and at least one gasket layer at least around the media passage opening, at least one gasket layer is provided with a sealing bead surrounding the media passage opening, and, for limiting the deformation of the sealing bead, at least one gasket layer is provided with a stopper, which surrounds the media passage opening at least substantially, and wherein the flat gasket has means for evening out the compression of the stopper of the installed flat gasket along the length of the stopper, characterized in that the means for evening out the compression comprise at least one component support element, which is arranged opposite a region of a component in which this component has a lower component stiffness compared to component regions immediately adjacent to this component region, and which, in a plan view of the flat gasket, is provided only over a longitudinal portion of the stopper and is configured such that, in the region of this stopper longitudinal portion, the flat gasket is locally thicker than in regions of stopper longitudinal portions immediately adjacent to this stopper longitudinal portion.

15. The sealing assembly according to claim 14, wherein the flat gasket is formed as a cylinder head gasket.

16. An at least substantially metallic flat gasket which is clampable between sealing faces of components facing towards one another and which has a gasket plate provided with at least one first and at least one second media passage opening and screw holes for the passage of mounting screws used to clamp the flat gasket, which gasket plate has (i) at least one gasket layer provided with at least one first media opening corresponding to a first media passage opening of the gasket plate, (ii) a sealing device for the at least one first media passage opening, and (iii) at least one component support device, wherein, in a plan view of the flat gasket, the component support device is arranged on the side of the sealing device facing away from the at least one first media passage opening and at a spacing from the sealing device, characterized in that the component support device has at least one first support element being elongate in a plan view of the flat gasket, and at least one second support element, which, in a plan view of the flat gasket, is provided only over a longitudinal portion of the first support element and is configured such that the clamped flat gasket is locally thicker in the region of this second support element than in regions of longitudinal portions of the first support element immediately adjacent to this second support element.

17. The flat gasket according to claim 16, wherein, in a plan view of the flat gasket, at least one component support device is arranged immediately adjacent to at least one second media passage opening.

18. The flat gasket according to claim 16, wherein at least one second media passage opening is a liquid passage opening.

19. The flat gasket according to claim 16, wherein the gasket plate has at least two gasket layers at least around the first and second media passage openings and at least the first support element is provided on a first of these gasket layers.

20. The flat gasket according to claim 19, wherein the second support element is provided on a second of these gasket layers.

21. The flat gasket according to claim 20, wherein the first and the second gasket layer are arranged directly one above the other in the gasket plate.

22. The flat gasket according to claim 16, wherein at least one of the first and second support elements is formed by a stamping of a gasket layer and the stamping forms at least one protrusion, which protrudes beyond a region of this gasket layer immediately adjacent to the stamping.

23. The flat gasket according to claim 16, wherein at least one of the first and second support elements is provided with a height profile, the height of which, based on a plane defined by the gasket plate, varies along the elongate first support element.

24. The flat gasket according to claim 16, which is configured as a cylinder head gasket, wherein the first media passage openings are configured as combustion chamber openings and at least one second media passage opening is/are configured as a liquid passage opening.

25. A sealing assembly comprising a substantially metallic flat gasket, which is clamped between components, wherein at least one of the components, in the direction perpendicular to the plane defined by the flat gasket, has a locally different component stiffness and the flat gasket has at least one first and at least one second media passage opening, screw holes for the passage of mounting screws used to clamp the flat gasket, a sealing device for the at least one first media passage opening, and at least one component support device, wherein, in a plan view of the flat gasket, the component support device is arranged on the side of the sealing device facing away from the at least one first media passage opening, at a spacing from the sealing device, characterized in that the component support device is opposite a region of a component in which this component has a lower component stiffness compared to component regions of this component immediately adjacent to this component region, and in that the component support device has at least one first support element being elongate in a plan view of the flat gasket, and at least one second support element, which in a plan view of the flat gasket is provided only over a longitudinal portion of the first support element and is configured such that the clamped flat gasket is locally thicker in the region of this second support element than in regions of longitudinal portions of the first support element immediately adjacent to this second support element.

26. The sealing assembly according to claim 25, wherein in a plan view of the flat gasket, at least one component support device is arranged immediately adjacent to at least one second media passage opening.
